(19) United States
(12) Patent Application Publication
(10) Pub. No.: US 2026/0113145 A1
(43) Pub. Date: Apr. 23, 2026

(54) EFFICIENTLY TRANSMITTABLE BIT SEQUENCE WITH RESTRICTED DISPARITY, AND ENCODED FORWARD ERROR CORRECTION

(71) Applicant: INOVA SEMICONDUCTORS GMBH, Munich (DE)

(72) Inventors: Fabian KLUGE, Perasdorf (DE); Roland NEUMANN, Bad Toelz (DE)

(73) Assignee: INOVA SEMICONDUCTORS GMBH, Munich (DE)

(21) Appl. No.: 19/425,573

(22) Filed: Dec. 18, 2025

Related U.S. Application Data
(63) Continuation of application No. PCT/EP2024/055992, filed on Mar. 7, 2024.

(30) Foreign Application Priority Data
Jun. 21, 2023 (EP) 23180790.0

(51) Int. Cl. H04L 1/00

(52) U.S. Cl. CPC H04L 1/0041; H04L 1/0057

(57) ABSTRACT

A method is for generating a bit sequence that can be transmitted efficiently and has a limited disparity and a limited run length. The proposed method allows data to be able to be transmitted particularly efficiently on a transmission channel. The physical behavior on a transmission channel can be deterministically controlled despite a reduction in resource requirements. Thus, according to the proposed method, bit errors are minimal and a transmission error can be corrected efficiently, i.e. with minimal technical effort. Furthermore, the encoders used are designed with a minimal number of gates, and the proposed method implicitly includes a form of nesting that allows so-called burst errors to be corrected particularly advantageously.

### CROSS REFERENCE TO RELATED APPLICATIONS

This application is a continuation of International Application No. PCT/EP2024/055992, filed on Mar. 7, 2024, which takes priority from European Application No. 23180790.0 filed on Jun. 21, 2023 the entire contents of each of which are incorporated by reference herein.

### TECHNICAL FIELD

The present invention is directed to a method for generating an efficiently transmittable bit sequence with a restricted disparity and a restricted run length. The proposed method allows data to be transmitted particularly efficiently over a transmission channel. One of the advantages of the invention over the prior art is that the physical behavior on a transmission channel can always be controlled deterministically despite a reduction in resource requirements. Thus, according to the proposed method, the bit errors are minimal and a transmission error can be corrected efficiently, i.e. with minimal technical effort. In addition, the encoders used are designed with a minimum number of gates and an interleaving is implicit in the proposed method, which is based on the fact that so-called burst errors can be corrected particularly advantageously. This implicit interleaving makes it possible to dispense with the conventional buffer memory required for explicit interleaving. In addition, the invention ensures that user data together with correcting metadata can be encoded advantageously with regard to transmission. According to the invention, it can be ensured that not only the user data is line-coded or line-encoded, but also the correction data. Optimized disparity is a quality feature for the transferability of data. Adverse disparity can mean that data cannot be transmitted properly via a data channel because it cannot be interpreted properly by the recipient. Another quality feature is data efficiency with regard to the ratio of transmitted user data and a further data volume that is not directly related to the content of the user data. This includes so-called header data. The proposed invention makes it possible to generate data streams that can be read out particularly efficiently and are also very efficient in terms of overhead data. This minimizes the so-called overhead of the user data, which in turn creates a particularly efficient process. The unambiguous interpretability on the receiver side also ensures that data does not have to be transmitted repeatedly, but can instead be read out on the receiver side with a high degree of error tolerance. In addition, the proposed method is particularly efficient, as data segments can be converted into sub-symbols or symbols made up of sub-symbols in parallel, and this parallel design only requires units that are technically simple to produce. Thus, the efficiency gain also relates to the hardware or runtime to be used. The invention is further directed to a correspondingly configured system arrangement as well as to a computer program product and a memory-readable medium with control commands which execute the method.

### BACKGROUND

US 2003/0237041 A1 describes a system and method for transmitting a packet over a data link. The packet may contain a data stream bounded by one or more frame symbols. Faulty frame symbols that result in valid data symbols may be mapped to invalid symbols.

U.S. Pat. No. 7,103,830 B1 shows that two types of encoding are integrated instead of performing each encoding independently of the other. The two encodings can be integrated by interleaving one or more actions of one encoding method (e.g., data encoding) between two or more actions of the other encoding method (e.g., line encoding). In some embodiments, the division of a data block (e.g., a byte) for line coding (e.g., DC equalisation coding) is performed before data coding (e.g., error correction coding).

U.S. Pat. No. 5,025,256 A describes an 8B/10B serial transmission code that ensures a balanced distribution of ones and zeros, has a maximum run length (code run) of 4 and achieves a transition density of 40% in the worst case. In addition, the code contains two special control characters that are unique in the encoded bit stream and can be used for synchronisation.

U.S. Pat. No. 4,486,739 A shows a binary, DC-balanced code and an encoding circuit for its implementation, in which an 8-bit information byte is translated into 10 binary characters for transmission via electromagnetic or optical transmission lines that have temporal and low-frequency limitations.

EP 3323219 A1 shows a method which makes it possible to read out an analog data stream via a data line in a particularly error-proof manner. Among other things, the amplitude of the signal is monitored and, particularly preferably, the signal is measured at the point at which the amplitude is at its maximum. This converts an analog data stream into a digital data set and the maximum amplitude ensures that the threshold value between 0 and 1 on the line is safely exceeded or undershot.

Various coding methods and data transmission methods are known from the state of the art, but all of them relate to application scenarios that can only be used to disadvantage in an automobile. For example, the state of the art often assumes that high computing power is available and that there are no high real-time requirements. In addition, the state of the art often assumes that the weight or reliability of the components to be used plays a subordinate role. The state of the art often refers to conventional computer networks, where reliability and low technical complexity are less important.

Furthermore, so-called forward error correction is known from the state of the art. Forward Error Correction (FEC) is a method of error correction in which additional redundancy information is added to the data. This redundancy allows the receiver to detect and correct errors without having to retransmit the packet. FEC is often used in high-speed Ethernet connections such as 10 Gigabit Ethernet (10 GbE) to ensure data integrity.

Based on this state of the art, there is a need to create a method or a system arrangement that enables data to be processed as quickly as possible due to the safety requirements in the automobile and that also requires little technical effort and minimizes the error rate during transmission, as retransmission is not possible if an error is detected. The low technical effort should consist of installing components that are as simple as possible, have a low weight and can also be produced efficiently in large quantities. Known methods and system arrangements from computer network technology cannot typically be used here, as weight savings and real-time running behavior are not decisive for a stand-alone PC or server. Although the heat to be dissipated generally poses a challenge for computer arrangements, energy efficiency in an automobile is of even greater importance, since in electromobility, for example, power consumption even influences the range of the automobile.

Further state of the art relates to the transmission of data in a serial data stream. For example, the state of the art provides for extensive description data to be sent along with the user data, indicating where the user data is located and how it is to be interpreted. In addition, it is known in the state of the art to discard individual data packets if they are not transmitted correctly. It is also known in the state of the art to resend data packets if they do not arrive at a sender on time or in an unexpected format.

When transmitting data serially, it is necessary to have as many ones and zeros as possible in the serial data stream. This is called disparity. A disparity of zero on average and also over a short period of time is desirable to avoid baseline drift during transmission. The baseline drift (DC voltage fluctuation) of the serial signal leads to bit errors. In extreme cases, transmission is not possible.

A minimum number of 0->1 or 1->0 transitions is required to be able to reliably recover the serial bits in the serial data stream at the receiving end without the need to transmit a clock. This means that the clock for recovering the serial data is generated locally at the receiver from the serial data stream. The so-called run length specifies how many identical bits (ones or zeros) can occur in succession without changing. A short run length is always desirable, as long run lengths no longer allow the clock to be reliably recovered from the serial data stream.

The task of the line code (in this case a block code) is now to generate a symbol with guaranteed disparity and guaranteed run length from any data words with any disparity and infinite run length. This leads to an overhead in the transmission. This means that more bits (in the form of symbols) have to be transmitted than occur in the net data word to be transmitted. This means that the required transmission speed (bandwidth) must be greater than the data rate of the data to be transmitted. This in turn means that systems require higher error rates or more effort, power, etc. than would be necessary to transmit the raw data.

The state of the art either has a high overhead (8B10B) or the quality of the coded signal in terms of disparity and run length is very poor, so that additional measures (complexity) such as scramblers are often necessary to improve the quality in terms of disparity or run length.

Accordingly, one task of the present invention is to create a method which generates a bit sequence which can be transmitted particularly efficiently and which can also be transmitted securely. In this context, efficient can refer to hardware efficiency, efficient decryption on the receiver side, the lack of need for redundant data transmission due to signals that cannot be interpreted and/or to the ratio of user data to overhang data. Furthermore, according to the invention, it should be possible to create or use particularly efficient hardware that enables runtime optimization through parallel processing. Furthermore, it is a task to provide a correspondingly equipped system arrangement, as well as a computer program product and a computer-readable storage medium with control commands which execute the method or operate the system arrangement.

### SUMMARY

The problem may be solved in accordance with this disclosure.

Accordingly, a method is proposed in an automobile for generating an efficiently transmittable bit sequence with a restricted disparity, a restricted run length and a line-encoded forward error correction, comprising providing an arbitrary bit sequence; segmenting the provided bit sequence into a predefined sequence of segments according to a respective predefined bit length; calculating a forward error correction for each of the segments or a plurality of segments of the same bit length; encoding each segment or a plurality of segments of the same bit position together with its or their forward error correction into one or more sub-symbols respectively, using the same encoding unit for the segments of the same bit position and the associated forward error correction from a plurality of encoding units, wherein a first subset of coding units actively controls a sign of the disparity of the subsymbol by inverting the disparity of the generated subsymbol to compensate for a disparity of a second subset of coding units, wherein a juxtaposition of the subsymbols results in the efficiently transmittable bit sequence together with the calculated forward error corrections.

In a preparatory process step, it is possible to provide a potentially infinite bit stream containing the arbitrary bit sequence. Depending on the application scenario, the data stream is already of any length and can in turn be divided into words or any bit sequence. This provides an output data stream with a bit sequence that is potentially of any length. However, this arbitrary length can be defined in a preparatory process step and can preferably be defined as 112 bits. As soon as the length or the bit length of the arbitrary bit sequence is defined, it is fixed in accordance with one aspect of the present invention. In this respect, an arbitrary length of the bit sequence in the sense of the present disclosure cannot be understood as arbitrary. Rather, the synonym of the arbitrary bit sequence may be a bit sequence whose length can be freely selected in advance and/or whose content corresponds to the data to be transmitted or at least part of the data to be transmitted.

In a preparatory process step, it is therefore possible to provide an output data stream which comprises the arbitrary bit sequence. This arbitrary bit sequence is then read from the output data stream and provided in a first method step.

Typically, the output data stream or the output bit sequence can have so many bits that the process is carried out iteratively in such a way that several arbitrary bit sequences are generated from the output bit sequence, segmented, converted into sub-symbols, optimized with regard to disparity and then transmitted. This means that the output bit sequence can also be of any length and can ultimately be transmitted in several complete symbols.

The coding units are present in a plurality, whereby each segment, which in turn corresponds to a part of the arbitrary or previously freely selectable bit sequence, is assigned a coding unit. This then converts the segment into a partial symbol, whereby the set of partial symbols concatenated corresponds to the symbol or the overall symbol of the bit sequence to be transmitted efficiently. Thus, according to one aspect of the present invention, an encoding unit is located in a logical path of the processing chain or the structural arrangement between a segment and a partial symbol.

The proposed method is particularly efficient, since the transmittable bit sequence has a particularly high degree of useful data compared to the prior art. For example, it is possible to transmit 128 bits, which have 112 bits of user data. Thus, the proposed method is already superior to the state of the art in this aspect. In addition, the creation of the transferable bit sequence is particularly efficient, as this can be done in parallel and coding units can be used for this purpose, which are particularly simple in design. In this context, simple means, for example, that very few circuits need to be installed in the coding units. The coding units do not have to have extensive logic and can even be optimized for a certain number of bits. Thus, according to embodiments of the invention, it is possible for the input and output of the respective coding unit to be fixed with regard to the number of bits.

Due to the optimized disparity of the bit sequence to be transmitted, it is possible to avoid errors when interpreting on a serial channel. Efficiency therefore also refers to the fact that the bit sequence is particularly error-resistant and can therefore only be reliably transmitted once. Redundant transmission is avoided due to the high detectability, again due to the optimized disparity.

In the serial transmission of data, it is advantageous to keep the number of ones and zeros in the serial data stream as equal as possible. This is generally referred to as disparity. For reliable clock recovery at the receiver, a run length restriction can be imposed on the generated channel sequence. This limits the maximum number of consecutive ones and zeros. Thus, the proposed method can also be described as a method for efficient coding of a bit sequence. According to embodiments of the invention, the disparity is optimized by cleverly setting partial disparities. This can be used particularly advantageously if the run length of the bit sequence is limited. The restricted disparity and the restricted run length can also relate to the arbitrary bit sequence provided. This means that it does not have to be the efficiently transferable bit sequence. Overall, the arbitrary bit sequence provided can be transmitted efficiently or a bit sequence to be transmitted is generated or created from this bit sequence, which can then be transmitted efficiently.

In a preparatory process step, an arbitrary bit sequence encoding user data is provided. Problems can occur in this arbitrary bit sequence, for example if there is an unfavorable disparity. For example, too many zeros can lead to problems during transmission. This is to be avoided and therefore the arbitrary bit sequence is optimized in further process steps so that it can now be transmitted efficiently. The arbitrary bit sequence provided therefore represents any user data that is to be sent from a transmitter to a receiver via a serial data channel. The arbitrary bit sequence can, for example, be control data in an automobile.

According to embodiments of the invention, the bit sequence provided is segmented into a predefined sequence of segments according to a predefined bit length. This means that the input data stream, i.e. the arbitrary bit sequence, is divided according to a predefined procedure so that individual data segments are created. The segments therefore cumulatively result in the arbitrary bit sequence. The predefined bit length has the advantage that coding units can be optimized in the same way that the respective bit length is taken into account. This makes it possible to create particularly efficient circuits that are highly specialized. Defined bit lengths are mentioned below, but these are only examples.

Each segment is encoded into a sub-symbol using one encoding unit per segment from a plurality of encoding units. The coding itself takes place in one coding unit, which finds one segment at the input and then converts this segment into a partial symbol. The partial symbol is also a bit sequence. Overall, the arbitrary bit sequence is therefore divided into segments, these segments are each converted into a sub-symbol by a coding unit and the entirety of the sub-symbols results in the coding of the arbitrary bit sequence to be transmitted. Overall, it is advantageous that the number of segments corresponds to the number of coding units and thus to the number of partial symbols. It is therefore possible for each segment to have exactly one coding unit, which in turn generates exactly one partial symbol from the segment. The number of coding units describes all the coding units to be used, which corresponds to the number of segments. The number of segments is predefined as a predefined bit length is specified. The method is therefore deterministic overall.

In order to achieve an overall advantageous disparity, there is a first subset of coding units that actively controls a sign of the disparity of the sub-symbol by inverting the disparity of the generated sub-symbol to compensate for a disparity of a second subset of coding units. This therefore means that there are subsets of coding units that control the sign of the disparity or not. Coding units of the first subset control this sign and coding units of the second subset do not control it. Coding units of the first subset can therefore be described as active and coding units of the second subset as passive. Due to the different subsets or types of coding units, it is possible to connect the coding units in series in such a way that coding units of the first subset also advantageously shape the overall disparity of the partial symbols from the coding units of the second subset.

According to embodiments of the invention, therefore, coding units are used which are arbitrary with regard to the disparity of the partial symbol. A coding unit of the first subset can then be connected in parallel, which controls the sign of the disparity of the preceding coding unit and its own coding unit or its subsymbols as a function of the disparity of the coding unit of the second subset. Thus, a certain number of coding units of the second subset is used and then another certain number of coding units of the first subset is used. In this way, the types or subsets of the coding units change in such a way that the next coding unit connected in parallel adapts the disparity of the previous subsymbol(s) and/or its own subsymbol. In this way, it is avoided that non-controllable coding units are connected in parallel one after the other in such a way that an unfavorable disparity occurs. Each coding unit of the first subset thus corrects the sign of the previously parallel-connected coding units or their sub-symbols. This parallel connection of coding units is described in more detail below with reference to FIG. 4.

In summary, it can therefore be concluded that coding units of the first subset optimize coding units of the second subset with regard to disparity. Optimizing a disparity means that the disparity is 0. How the skilled person calculates disparities or sets them, for example by changing the sign, is sufficiently well known to the skilled person.

According to the proposed method, sub-symbols are therefore created which are optimized in their sequence with regard to disparity. As each segment is converted into a sub-symbol, the (overall) symbol to be transmitted can be generated by stringing the sub-symbols together. This can be transferred in a particularly efficient or error-tolerant manner, as the disparity or partial disparities are optimized. This results in a particularly advantageous bit sequence to be transmitted.

According to one aspect of the present invention, the arbitrary bit sequence is unrestricted in its disparity and run length. This has the advantage that any amount of user data can be transmitted or can be converted into a bit sequence which is restricted in terms of disparity and restricted in terms of run length. Thus, any bit sequence is encoded into a bit sequence to be transmitted, which is optimized in its disparity and run length.

According to a further aspect of the present invention, the disparity of the second subset of coding units is not controllable. This has the advantage that any subsymbol can be generated using the coding units of the second subset, whereby particularly simple coding units are to be used. These can be designed to be particularly simple, since the generated partial symbol of this coding unit is not subject to any restriction in terms of disparity or run length.

According to a further aspect of the present invention, the active control of the sign is carried out by means of conditional inversion of the partial symbol. This has the advantage that the corresponding subsymbol of the coding units of the first subset can be controlled in a simple manner. Only the disparity or individual bits of the partial symbol need to be inverted. The sign refers to the disparity of the partial symbol, which can be positive or negative.

According to a further aspect of the present invention, the conditional inversion takes place as a function of the disparity of an overall symbol, which is formed from all partial symbols. This has the advantage that not only partial symbols are optimized, but also the entire, i.e. the combined partial symbols, i.e. the overall symbol is optimized with respect to the disparity. This results in a particularly advantageous overall symbol.

According to a further aspect of the present invention, the dependency is influenced in such a way that a magnitude value of the disparity is minimized. This has the advantage that the lowest possible disparity, preferably 0, is achieved. Disparities are thus linked with each other in such a way that the amount of the disparities is as low as possible or as low as possible.

According to a further aspect of the present invention, the amount value is minimized in such a way that if the total symbol disparity is positive, it is counteracted by a negative parity of the sub-symbols. This has the advantage that the positive total symbol disparity is minimized or eliminated.

According to a further aspect of the present invention, the magnitude value is minimized in such a way that a negative total symbol disparity is counteracted by a positive parity of the sub-symbols. This has the advantage that the total symbol disparity is minimized or eliminated overall.

According to a further aspect of the present invention, the active control takes place as a function of already transmitted total symbols, such that the disparity of all total symbols is minimized. This has the advantage that several total symbols are minimized with respect to their disparity or the disparity is eliminated and thus several sequences of total symbols are also optimized with respect to their transferability.

According to a further aspect of the present invention, coding units of the first subset encode segments of 11 bits to subsymbols of 13 bits. This has the advantage that 11 bits are encoded particularly efficiently and only 2 bits of additional effort are required for this. This is particularly advantageous if a total symbol of 128 bits is to be created. In general, the specific values of the proposed technical teaching mentioned here were determined empirically and can be proven by the fact that only an additional effort of 128-112 bits, i.e. 14%, is necessary. Thus, the values listed here are proven to be advantageous for a transmission of 112 bits.

According to a further aspect of the present invention, coding units of the first subset have a disparity between +3 and +9, which are specifically inverted to −3 to −9 by inversion. This has the advantage that, for example, a disparity of +3 is canceled with a disparity of −3, which is done analogously when adjusting the disparity of +9 with a disparity of −9. This in turn is particularly advantageous for any bit sequence of 112 bits, which is to be encoded as 128 bits.

According to a further aspect of the present invention, the run length in sub-symbols is a maximum of 7. This has the advantage that a maximum of 7 equal instances of zeros and ones are generated, which is particularly advantageous in the proposed scenario of 112 bits or 128 bits.

According to a further aspect of the present invention, the run length of the subsymbol for coding units of the first subset is a maximum of 5, starting from the most significant and/or the least significant bit. This has the advantage that a maximum of 5 identical bits can be present at the end or at the beginning of a subsymbol. This has also proved to be particularly advantageous in the scenario described.

According to a further aspect of the present invention, in coding units of the second subset, 11 bit segments are coded to 12 bit sub-symbols or 7 bit segments are coded to 8 bit sub-symbols or 6 bit segments are coded to 8 bit sub-symbols. This has the advantage that, in the scenario of 112 bits to be transmitted in a symbol of 128 bits, this coding produces particularly advantageous values which have a minimized overhang of only 14%.

According to a further aspect of the present invention, a disparity between −2 and +2 is generated for coding units of the second subset. This has the advantage that again particularly advantageous disparities are generated.

According to a further aspect of the present invention, in encoding units of the second subset, the run length in the generated subsymbol is 6. This has the advantage that, again, particularly optimized subsymbols are generated.

According to a further aspect of the present invention, encoding units of the second subset generate partial symbols which have a maximum run length of 3 at the edge. This has the advantage that partial symbols which are created by the second subset of coding units have a maximum run length of 3 at the beginning or at the end, which is a particularly advantageous value.

According to a further aspect of the present invention, the coding units are addressed in parallel and one segment is coded into a partial symbol in each case. This has the advantage that a segment is converted into exactly one partial symbol with exactly one coding unit. Thus, the coding units can be addressed in parallel, since segments are formed from the arbitrary bit sequence, which can be converted into partial symbols in parallel.

According to a further aspect of the present invention, the coding units are addressed in the sequence 21212221212, where a 1 stands for a coding unit of the first subset and a 2 for a coding unit of the second subset. This has the advantage that a non-actively controlled number of coding units is always followed by a single coding unit which can be actively controlled. In this respect, it was empirically determined that a particularly advantageous overall symbol results from the proposed coding units.

According to a further aspect of the present invention, when a positive data stream and a negative data stream are applied, a multiplexer selects the data stream that contributes to minimizing the overall disparity of the overall symbol. This has the advantage that a suitable data stream can be selected which has a sign that minimizes or eliminates the disparity. If, for example, the disparity to be optimized is negative, a data stream with positive disparity is selected, which then minimizes or compensates for this data stream with respect to its disparity.

According to embodiments of the invention, the forward error correction is improved by calculating it with respect to user data and by first segmenting the user data for this purpose. A separate forward error correction is then calculated for each segment, so that the forward error correction does not relate to an entire data word, but to different subwords. This keeps the number of gates of the FEC coders to be used low and avoids exponential growth. In addition, an improvement results from the fact that a line coding is carried out via the user data together with the forward error correction, thus overcoming the disadvantage in the prior art that the forward error correction is transmitted in a non-coded form. Furthermore, it is advantageous that the error correction can work more efficiently, since the error correction only refers to partial words and can therefore recognize in fine granularity where an error has occurred. Conventional error corrections always refer to entire data words and are therefore inefficient or errors can occur in the prior art that cannot be corrected. This is avoided by the segmentation according to this disclosure.

A further improvement is that all transmitted data is line coded and therefore all data can benefit from line coding. The transmission link can therefore be controlled deterministically and bit errors are kept to a minimum. In addition, implicit interleaving results from the fact that smaller packets are sent and thus implicit interleaving occurs, as not all of the data words are transmitted. This is achieved by using several forward error correction encoders, each of which refers only to partial words. Thus, according to embodiments of the invention, the disadvantage in the prior art of having to create an explicit interleaving at great expense, which would also require additional buffer memories, is overcome.

Due to the optimized disparity (line coding) of the bit sequence to be transmitted, it is possible to avoid errors when interpreting on a serial channel. Efficiency therefore also refers to the fact that the bit sequence is particularly error-resistant and can therefore only be reliably transmitted once. Redundant transmission is avoided due to the high detectability, again due to the optimized disparity.

In the serial transmission of data, it is advantageous to keep the number of ones and zeros in the serial data stream as equal as possible. This is generally referred to as disparity. For reliable clock recovery at the receiver, a run length restriction can be imposed on the generated channel sequence. This limits the maximum number of consecutive ones and zeros. Thus, the proposed method can also be described as a method for efficient coding of a bit sequence. According to embodiments of the invention, the disparity is optimized by cleverly setting partial disparities. This can be used particularly advantageously if the run length of the bit sequence is limited. The restricted disparity and the restricted run length can also relate to the arbitrary bit sequence provided. This means that it does not have to be the efficiently transferable bit sequence. Overall, the arbitrary bit sequence provided can be transmitted efficiently or a bit sequence to be transmitted is generated or created from this bit sequence, which can then be transmitted efficiently.

The proposed method can be used specifically in the vehicle or is specially tailored to the requirements in the vehicle. This is the case because safety-critical functions are offered in the vehicle, which must be protected accordingly. According to embodiments of the invention, this is done in several ways. On the one hand, through forward error correction and via line coding. In addition, the reduced number of gates required is particularly advantageous in electromobility.

According to embodiments of the invention, user data to be transmitted is provided in a preparatory process step. This is typically a bit sequence of a fixed length. This can also be referred to as a data word.

The user data provided is then divided into a number of bit sequences of the same length. In a preferred embodiment, these bit sequences can have a length of 112 bits. While the user data can be a continuous data stream, the bit sequences are always of a certain length and provide a subdivision of the user data in a certain way. In the following, a bit sequence is also referred to as a data word. Furthermore, it is assumed in the following, especially in the figures, that the bit sequences are arranged one below the other, figuratively speaking. This means that each individual bit sequence extends horizontally and the individual bit sequences are arranged vertically one below the other.

Since the bit sequences are now segmented, a subdivision rule is read out, which divides a bit sequence into a sequence of segments of a predefined length at a predefined position. The subdivision rule can be in the form of a data format that defines how long a segment must be. The individual segments do not have to be the same length; this can vary from segment to segment. However, the subdivision rule stipulates that the individual bit sequences each have the same format, so that, figuratively speaking, the same subdivisions result vertically. For example, a first segment of each bit sequence can have 11 bits. For example, the first four segments can also each have 11 bits, followed by a segment of 7 bits. This can be followed by another segment with 11 bits and then a segment of 6 bits. This data format is maintained for all bit sequences. This means that the segments at the same position can always be of the same length, although the segments can differ vertically, figuratively speaking. The segments per line then form the bit sequence. The bit sequences in their vertical arrangement form the user data in their entirety.

This means that the read-out subdivision rule is applied to all bit sequences of the multiple bit sequences until the entire user data is broken down horizontally into bit sequences and the segments are formed vertically. This means that all bit sequences are subdivided according to the same subdivision rule. The subdivision rule can be read from a data memory and applies to all bit sequences obtained from the user data.

Now an iterative creation of a partial forward error correction for all segments of the same bit position takes place across all bit sequences. Thus, figuratively speaking, a forward error correction is calculated for all vertical segments that are in the same bit position or the same sequence for all segments. This is carried out for all segments so that partial forward error corrections have been created for all bit sequences and therefore for the complete user data. The total of all partial forward error corrections thus creates a total forward error correction that relates to the complete user data or all bit sequences.

In general, it is also possible that the user data is only divided into one bit sequence or that the user data is already available in its length as one bit sequence. A partial forward error correction is then generated for each segment.

Now an iterative application of a segment encoder is carried out over all segments of the same bit position to generate segment line codes over all segments per bit position and per bit sequence. In other words, line coding is carried out over all vertical segments, figuratively speaking. This is advantageous in that line encoders are provided specifically for predetermined lengths. This ensures that the vertical segments can each be encoded by a single line encoder. The iterative application of the segment encoders thus ensures that, figuratively speaking, the segments are line-encoded column by column and this is done across all segments until all bit sequences are line-encoded with respect to their segments.

It is particularly advantageous that the partial forward error correction has the same number as the respective segments. This means that the partial forward error correction can be encoded using the same line encoder as the corresponding segments.

In each case, the segment encoder that was also used for the segments in relation to which the respective partial forward error correction was created is applied to the respective partial forward error correction to generate one partial forward error correction line code for each partial forward error correction. This means that those segment encoders are used that have line-encoded the respective segments and then also line-encode the respective partial forward error corrections. This means that the segments are line-encoded column by column with the same segment encoder as the partial forward error corrections that relate to the respective column.

All segment line codes and all partial forward error correction line codes are then transmitted.

According to one aspect of the present invention, the subdivision rule is stored in a data memory and is present as a coding rule and/or is read out from a hardware architecture. This has the advantage that the subdivision rule can be statically predefined or can also be changed in the data memory. In addition, the subdivision rule can take the corresponding hardware architecture into account. If, for example, different encoders are provided for different bit lengths, the bit sequences can be subdivided in such a way that the corresponding segments correspond to the respective encoders. The segments therefore have exactly the length provided by the respective encoder.

According to a further aspect of the present invention, all bit sequences have the same structure in their data format, have the same segment lengths and/or the same bit positions. This has the advantage that the individual segments can be fed to the respective encoders. For example, each first segment of each bit sequence is fed to the same encoder. Thus, figuratively speaking, the segments can be encoded column by column and there is a specialized encoder for each column.

According to a further aspect of the present invention, the partial forward error correction has correction information which describes a target content of the segment over which the partial forward error correction was created. This has the advantage that the transmitted data can be corrected by means of this correction data, whereby an entire correction is not formed for each bit sequence, but rather individual partial forward error corrections are formed for the individual segments. All partial forward error corrections in their entirety describe all segments of all bit sequences and therefore all user data. However, the difference to the state of the art here is that a forward error correction is not formed for each bit sequence, but for all segments across all bit sequences. It is thus possible to use the same line encoder for each partial forward error correction that is used for the corresponding segments.

According to a further aspect of the present invention, the partial forward error correction has the same bit length as the segment over which it is generated. This has the advantage that specialized line encoders can be provided and thus maximum efficiency is achieved in that the corresponding column-wise line encoders are specialized for exactly the bit length that they then also have to encode. This creates an efficient and technically minimally complex process.

According to a further aspect of the present invention, an entirety of the partial forward error corrections describes all user data to be transmitted in a correctable manner. This has the advantage that all user data which are transmitted can be corrected with respect to their errors, but in this case the individual segments can be taken into account, so that the proposed method is more finely granular than the prior art provides for.

According to a further aspect of the present invention, the segment encoders each generate at least part of a line code. This has the advantage that the outputs of the segment encoders can be combined and then provide the line codes to be transmitted.

According to a further aspect of the present invention, the set of segment encoders encodes bit sequences of 112 bits into words of 128 bits. This has the advantage that a particularly efficient line code is created.

According to a further aspect of the present invention, the partial forward error correction line codes are appended to the segment line codes during transmission. This has the advantage that all data to be transmitted are line coded and thus the line is operated deterministically or the advantages of line coding can be utilized for all data and not only for the payload data per se.

According to a further aspect of the present invention, the bit position is specified as an offset or as a bit index in the bit sequence. This has the advantage that different addressing types can be used and the index is based on an order of the respective segments, which can then be advantageously specified using known methods.

According to a further aspect of the present invention, the user data is available as a serial data stream. This has the advantage that theoretically any amount of user data can be transmitted, which is then divided into bit sequences of the same length.

According to a further aspect of the present invention, the method steps are carried out in the described sequence and/or are carried out iteratively. This has the advantage that the coding sequence is reversed. According to embodiments of the invention, it is provided that the forward error correction is created first and then the line coding is performed. This does not exclude the possibility that individual process steps have to be carried out several times. This may be the case, for example, if several bit sequences are present and these have to be segmented.

According to one aspect of the present invention, a line code segment is generated for each data subword block and/or each data subword block forward error correction. This has the advantage that the forward error correction in particular does not have to be transmitted uncoded, but rather is also line-coded. Thus, the advantages of line coding are not only available for the user data but also for the forward error correction.

According to a further aspect of the present invention, a forward error correction for a data block is composed of several partial forward error corrections of the data subword blocks. This has the advantage that not an entire forward error correction is initially generated, but many individual partial forward error corrections, which in their entirety form an overall forward error correction. In this way, the number of gates of the required FEC encoders is kept to a minimum. Nevertheless, it is possible to protect all data by means of a forward error correction and, in addition, to transmit the data together with the forward error correction FEC in line coded form.

According to a further aspect of the present invention, the data structure is read out and a forward error correction sub-encoder is selected depending on the respective bit lengths of the data sub-words. This has the advantage that the FEC encoders are precisely tailored to the segment lengths or the bit lengths of the subwords. In this way, it is possible to minimize the number of gates so that the encoders only have to create encodings for small subwords and not for the entire data words. Consequently, each FEC encoder is precisely tailored to the bit length of the data subword to be encoded.

According to a further aspect of the present invention, the number of gates of the FEC partial encoders is selected as a function of a bit length of the data subwords. This has the advantage that, compared to the prior art, the number of gates required in the FEC encoders is reduced and thus an efficient system arrangement or an efficient method is created, which is particularly advantageous in the automobile or in the vehicle. In this way, no gates need to be provided that would not be necessary. This results in a deterministic and minimal number of gates.

According to a further aspect of the present invention, the number of all gates of all encoders is selected in such a way that iterative execution of the method results in a linear increase in the number of gates with respect to increasing data word lengths. This has the advantage that, taking into account the data format, a minimum number of gates is provided or that the data format can be selected in such a way that only a linear increase in the number of gates is necessary. For example, in one embodiment, the maximum bit length can be 10, 11 or 12 bits, which means that the required gates or circuits of the FEC encoder only increase linearly. Since an exponential growth of gates is necessary for larger values, embodiments of the present invention create the technical effect that the power consumption or energy consumption is minimized, which in turn leads to less waste heat. In addition, the proposed method is particularly robust, which is particularly advantageous in automobiles, as safety-critical functions are offered here.

According to a further aspect of the present invention, each data word has 112 bits. This has the advantage that words of 128 bits can be created with line coding, which corresponds to a common format. According to embodiments of the invention, it has been shown that 112 bits in particular can be encoded robustly 128 bits. This ensures that the transmission is subject to a lossy or error-prone data channel.

According to a further aspect of the present invention, the bit length of the data subword block forward error correction is selected such that it corresponds to the bit length of the data subwords. This has the advantage that both the forward error correction and the data subwords or segments can be encoded using the same encoder, which is the line encoder, i.e. not the FEC encoder. Thus, embodiments of the present invention make the technical contribution that not only a minimum number of gates must be provided, but also the total number of encoders is minimized. Thus, the forward error correction can be line coded with the same encoder as the actual segments of the user data.

According to a further aspect of the present invention, the data subword block forward error correction and the data subword block on the basis of which the data subword block forward error correction is calculated are line-encoded using the same line encoder. This has the advantage that a minimum number of line encodings must be provided. Figuratively speaking, virtually all columns, i.e. all partial word blocks together with the corresponding partial forward error correction, are line-encoded with the same segment encoder in each case.

According to a further aspect of the present invention, the data structure is selected as a function of the bit length of the data words. This has the advantage that the different bit lengths can also be dealt with dynamically at runtime and thus the same data format can be selected for further data words as for a first data word provided. If first data words are available, a corresponding data structure can be used for a further serial data stream and the further data words are structured in such a way that they correspond to the data structures of the data words received first.

According to a further aspect of the present invention, serial line coding is performed after the data subword block forward error correction has been calculated. This has the advantage that the order as provided in the prior art is reversed and the forward error correction is calculated first, which means that it can also be line coded and does not have to be transmitted unencrypted or uncoded.

According to a further aspect of the present invention, the method steps are performed in a virtualized manner and information about the underlying encoders and/or gates is generated. This has the advantage that the embodiments can be evaluated in a preparatory process step and, in this respect, it can be determined how many gates or how many FEC encoders and/or line encoders are to be provided. In addition, the process as a whole can be simulated. Hardware components can be provided virtually.

One aspect of the present invention is to bundle several data streams (video, audio and data) in one transport frame and transmit them serially. The different data formats not only have different bandwidth requirements, but also different latency, reassembly sublayer and bit error rate requirements. In particular, the transmission of today's video data formats requires not only the transmission of pure video data and its frame information, but also the support of encryption methods such as HDCP. All of this requires many different data channels with a wide range of requirements in terms of bandwidth, latency, reassembly sublayer, etc. Added to this is the desire for far more complex network architectures than a simple transmitter/receiver architecture offers. Architectures with several repeaters, where data paths can begin and end, branches (Y) also with the possibility of reintegrating data paths into a link, are advantageous.

According to one aspect of the present invention, the technology follows the basic idea of bundling services quite consistently, but offers completely new possibilities with regard to network architectures and allows new approaches in the implementation of today's video interfaces. In addition, it can be used as a universal data transport layer, for example also for the transmission of Ethernet or camera data or any kind of sensor data.

With a virtual path, all packets/cells take the same path, in contrast to IP, where a packet could reach its destination via a different route than previous and subsequent packets. Latency and reassembly sublayers over a virtual path are therefore constant.

Virtual paths also have the advantage that they can be used as multiplexing offshoots for different services (video, audio, Ethernet), as the properties of the virtual paths can be configured differently without the different virtual paths interfering with each other.

Virtual paths only consume bandwidth when data is actually being transmitted.

The concept of virtual paths also makes it possible to realize complex and far-reaching diagnostic and network configuration functions at runtime with dedicated (virtual) data channels.

According to one aspect of the present invention, a virtual path layer is implemented between the physical layer (serializer and framer) and the various application data interfaces.

According to one aspect of the present invention, this is used to multiplex the different data paths and support more complex architectures with repeaters and branches. This is mainly done in the cell layer.

According to an aspect of the present invention, a further part of the virtual path layer is an application adaptation layer which performs the conversion of video (stream) or e.g. Ethernet (packet) data into the cells. This application adaptation layer also comprises the OAM functions for network diagnostics and management.

In accordance with one aspect of the present invention, the technology can be the basis for transmitting a variety of data formats over a serial link in the car (and elsewhere). It thus forms the basis for a new generation of devices.

The high serial bandwidths make it necessary to define architectures, cell formats and interfaces that allow flexible internal data bus widths in order to adapt the speed of the internal timing system to the capabilities of the chip technology.

According to one aspect of the present invention, the virtual path layer is the physical layer consisting of the transmission sublayer and the physical medium sublayer, the cell layer and the application adaptation layer containing the segmentation and reassembly sublayers and the functions for adapting the data formats to the corresponding application.

The main task is to establish the physical connection to other physical layers. This connection is basically bidirectional. Theoretically, this connection can be realized via a wide variety of media. In practice, two serial differential GBps connections are used. In this layer, the line coding, the insertion of empty cells to decouple the cell rate from the connection rate and the integration of the cell stream into the serial frame take place.

In the cell layer, the segmented data (cell payload data) of the segmentation & reassembly sublayer above is assembled into complete cells with header, VP identifier and CRC, or cells are CRC-checked and the payload is passed on to the segmentation and reassembly sublayer. This is also where the multiplexing of the different cell streams of the application adaptation functions or the distribution of the cell payloads to the application adaptation functions according to the VP identifier takes place. (Feed-in/Feed-out)

According to one aspect of the present invention, multiplexing and demultiplexing of cell streams in repeaters and splitters (forwarding) also takes place in the cell layer.

According to one aspect of the present invention, the task of the application adaptation functions is to adapt the data of the application interfaces to the format of the user data field of the cell and to transmit control information to the opposite side or to transmit control information of the opposite side for the adaptation to be used (time generation, frame formation).

According to an aspect of the present invention, all virtual data paths are unidirectional, i.e. they start at an initiator and end at one or more targets. If virtual data paths logically belong together, e.g. HDCP for a video channel, and thus form a bidirectional data path, these paths should have the same VP identifiers.

The virtual data path starts at an initiator and ends at one or more targets. It is realized by the cell sublayer and performs the following functions on the virtual path:
Add/delete multiplexing
VP translation

### Stream Data (Continuous Data Stream)

The stream data function combines the time domain crossing and the bit width conversion of data from the application interface to the N bits of the cell rows. The cell row payload is already preformatted so that the cell footer and header fit into the first and last cell row.

Streamed data is (normally) source-synchronous. Here, the clock domain crossing of the data path from the application clock domain to the Virtual Path Layer clock domain is performed.

A data buffer is provided in the sending direction, into which the source-synchronized data is written with the source clock. The segmentation layer retrieves the data from this buffer as required in order to perform the data format conversion into the N-bit wide rows of the cells. Frame data (e.g.: Hsync, Vsync, DE) is encoded in payload info bits so that the frame can be reconstructed on the receiver side.

In the receive direction, the cell data from the reassembly sublayer is written to a data buffer, whereby the cell row bit width is (with cell row bit width). The frame information is reconstructed based on the payload info bits. The source clock is regenerated, for example, using buffer fill level and clock synthesis.

If data encryption is required (HDCP), the cell data is encrypted or decrypted in this function.

Due to the different types of streamed data, such as: Audio, video with and without encryption, there may be different implementations of this basic function (e.g.: VStream In/Out; AStream In/Out; EncVStream In/Out).

The interface to the segmentation & reassembly sub-layer is the same for all functions.

### Burst Data (Discontinuous Data Stream)

The burst data function combines the clock domain crossing and data bit wide conversion of data from the application interface to the N bits of the cell rows. The cell row payload is already preformatted so that the cell footer and header fit into the first and last cell row.

Burst data is (normally) synchronous to an external time and has different identification signals for direction and data type (address/data/ByteEnable).

This data is normally accompanied by control lines in order to realize a specific protocol.

A data buffer is provided in the sending direction, into which the burst data is written with the interface clock. The segmentation layer retrieves the data from this buffer as required to perform the data format conversion into the N-bit wide rows of cells.

In the receive direction, the cell data is written to a data buffer by the reassembly sub-layer, where the cell row is bit-wide. The interface control signals are reconstructed based on the payload info bits.

The payload info bits are used to generate the control signals of the application-specific interfaces or to synchronize the protocol state machines in the application-specific interfaces.

Due to the different interfaces that provide burst-like data (SPI, I2C, MII), there may be different implementations of this basic function (e.g.: SPIBurst, I2CBurst, MIIBurst).

Accordingly, there will also be (slightly) different stream in/out interfaces, but their structure should be the same.

The problem is also solved by a system arrangement in an automobile for generating an efficiently transferable bit sequence with a restricted disparity and a restricted run length, comprising an interface unit set up for providing any bit sequence; a segmentation unit set up for segmenting the provided bit sequence into a predefined sequence of segments in accordance with a respective predefined bit length; a calculation unit set up for calculating a forward error correction for each of the segments or a plurality of segments of the same bit length; an encoding arrangement arranged for encoding each segment or a plurality of segments of the same bit position together with its/their forward error correction into one or more partial symbols in each case, using in each case the same encoding unit for the segments of the same bit position and the associated forward error correction from a plurality of encoding units, wherein a first subset of coding units actively controls a sign of the disparity of the partial symbol by inverting the disparity of the generated partial symbol to compensate for a disparity of a second subset of coding units, wherein a juxtaposition of the partial symbols results in the efficiently transmittable bit sequence together with the calculated forward error corrections.

The problem is also solved by a computer program product with control instructions which implement the proposed method or operate the proposed device.

According to the invention, it is particularly advantageous that the method can be used to operate the proposed devices and units. Furthermore, the proposed devices and units are suitable for implementing the method according to the invention. Thus, in each case the device implements structural features which are suitable for carrying out the corresponding method. However, the structural features can also be designed as method steps. The proposed method also provides steps for implementing the function of the structural features. In addition, physical components can also be provided virtually or virtualized.

### BRIEF DESCRIPTION OF THE DRAWINGS

Further advantages, features and details of the invention are provided in the following description, in which aspects of the invention are described in detail with reference to the drawings. The features mentioned in the claims and in the description may each be essential to the invention individually or in any combination. Likewise, the above-mentioned features and those further described here can be used individually or in any combination. Functionally similar or identical parts or components are sometimes provided with the same reference signs. The terms “left”, “right”, “top” and “bottom” used in the description of the embodiments refer to the drawings in an orientation with a normally legible figure designation or normally legible reference signs. The embodiments shown and described are not to be understood as conclusive, but are of an exemplary nature to explain the invention. The detailed description is for the information of the person skilled in the art, therefore known circuits, structures and methods are not shown or explained in detail in the description so as not to impede the understanding of the present description. The figures show:

FIGS. 1A-C provide several examples of a process flow with serial coding and calculation of a forward error correction according to the prior art;

FIG. 2 illustrates an optimized process flow with forward error correction and serial encoding according to an aspect of the present invention;

FIG. 3 illustrates an encoding of user data and a calculation of a forward error correction according to the prior art;

FIG. 4 illustrates a method for improving forward error correction in serial encoding in an in-vehicle data transmission according to the present invention;

FIG. 5 illustrates a comparison of the prior art coding and the method for improving forward error correction according to an aspect of the present invention;

FIG. 6 illustrates a diagram illustrating the required number of gates per bit length of forward error corrections;

FIG. 7A shows an encoding of user data into a line code according to an aspect of the present invention;

FIG. 7B shows the proposed system arrangement for improving forward error correction in serial coding in a data transmission in the vehicle according to an aspect of the present invention;

FIG. 8A shows an aspect of the method for improving forward error correction according to an aspect of the present invention at the transmitter side;

FIG. 8B shows a method for improving forward error correction on the receiver side according to an aspect of the present invention;

FIG. 9 is a flowchart of a method for improving forward error correction in serial coding in a data transmission according to an aspect of the present invention;

FIG. 10 shows a basic frame format and application of a so-called block code according to an aspect of the present invention;

FIG. 11 is a schematic diagram of a layout and structure of the so-called block code according to another aspect of the present invention;

FIG. 12 is a schematic diagram of a frame format as it may find application according to the invention; and

FIGS. 13, 14, 15, 16 show exemplary encodings of data segments to symbols such that the disparity is optimized according to an aspect of the present invention.

### DETAILED DESCRIPTION

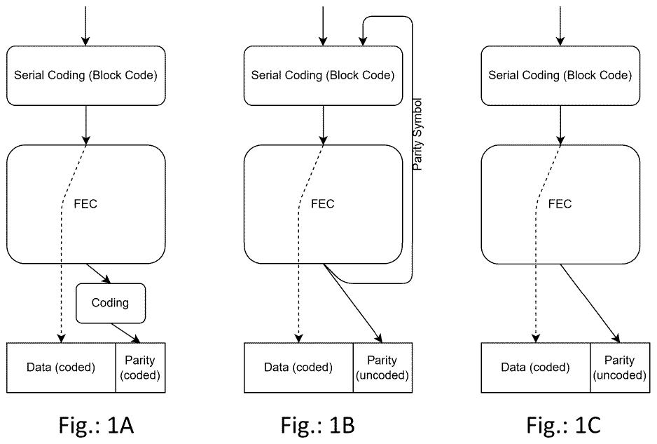

FIG. 1 shows three examples of how forward error correction is performed according to conventional methods. On the left-hand side, an example is shown which first performs serial coding of the user data and then generates a forward error correction code FEC. The serially encoded data is transmitted and the forward error correction is subsequently encoded and then appended to the encoded user data. Thus, according to this example from the state of the art, the forward error correction is generated via a complete data word and this must then be encoded again and is appended. Coding is therefore not carried out via the individual segments, but via the bit sequence as a whole.

The center shows another prior art example in which the line coding step of the forward error correction is omitted and non-encoded parity information is appended. The disadvantage here is that the last data part, i.e. the parity information, is not line-coded and is therefore highly error-prone.

The right-hand side shows an example which, in contrast to the example in the middle, does not loop back the parity information for serial coding. This has the same disadvantages as the example in the middle.

Data transmission solutions always place stricter requirements on freedom from errors/error tolerance, which require fine tuning between serial coding and forward error correction (FEC) as data rates continue to increase.

The current state of the art (Ethernet/DisplayPort) processes the data stream in the following sequence:
1. The input data is encoded in the first step using serial encoding (8b10b, 64b66b, 128b132b etc.). For larger encodings from 64b66b upwards, this is primarily achieved by scrambling using LFSR.
2. The serial coded stream is now additionally protected against bit errors by means of FEC (Forward Error Correction) coding. A complete FEC coding (FEC coding word) contains both the input data on a symbol basis as well as the so-called parity symbols. For these applications, the input data is passed through the FEC untouched. This means that they always correspond to the original serial code. There are now the following further procedures:
   a. The parity symbols are now also serially coded afterwards (e.g. 8b10b) in order to fulfill the requirements for serial transmission (run length, DC balance etc.). This additional subsequent coding of the parity symbols requires an additional encoder in hardware.
   b. Instead of the aforementioned subsequent serial coding of the parity symbols, there are also solutions with feedback of the parity symbols to step 1.). With a serial encoder, it is possible to control the DC balance based on the selection of a positive or negative symbol. However, this is associated with a corresponding dead time (depending on the sizes of the serial coding and the FEC encoder). This can, for example, lead to a large deviation in the amount of the temporary DC balancing.
   c. The parity symbols are sent untreated directly to the serial link (e.g. DisplayPort 2.0). However, this is very inaccurate as the parity symbols are generated depending on the input data. Here one relies on the fact that the parity symbols are DC-balanced on average.

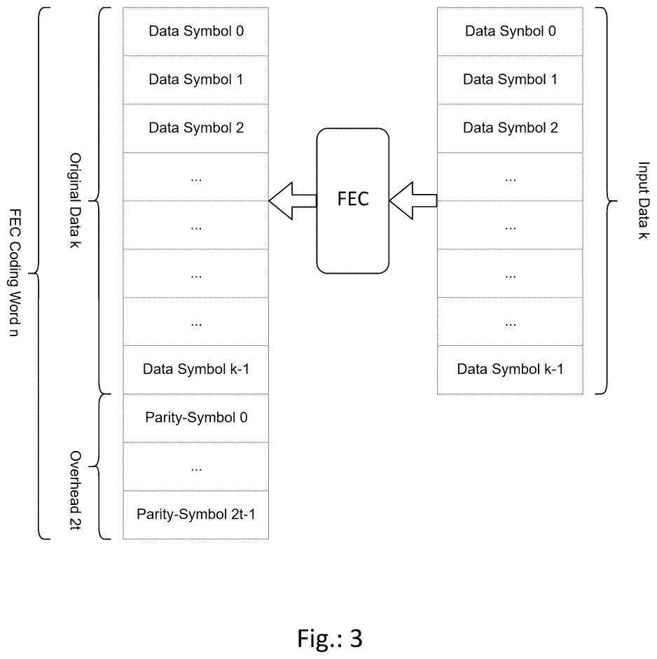

All the methods mentioned (a-c) have the disadvantage that they require a large amount of resources (e.g. two serial encoders) or lead to insufficiently accurate serial coding (e.g. DC balancing, run length, spectrum). In combination with the transmission channel, inaccurate control of the serial coding in particular can lead to the data stream not being reconstructed correctly on the receiver side (CDR samples incorrectly). These effects are mitigated in operation with FEC (as it corrects bit/symbol errors), which unnecessarily deprives the FEC encoding of correction margin for further necessary error correction for errors caused by signal integrity or e.g. external influences with each error caused by the poor serial encoding. A Reed Solomon FEC can only correct t symbol errors based on the size of the overhead (2t see FIG. 3) in symbols.

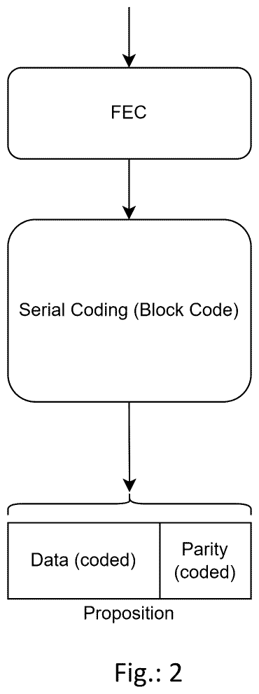

FIG. 2, on the other hand, shows the method according to embodiments of the invention, in which forward error corrections are generated via the user data and these are then also encoded with the user data. The advantage here is that both the user data and the forward error correction are line-coded and therefore errors are robust. This figure also shows that the difference to the prior art is that the forward error correction is generated directly on the user data and not on the line-coded user data. This then makes it possible to transmit all data in line-coded form, which in turn results in increased error robustness.

The method proposed below to improve the above-mentioned problems applies to all conceivable ECC/FEC encodings and is not only applicable to Reed Solomon codes.

The procedure presented changes the sequence of serial coding and FEC:
1. The input data is protected in the first step by means of FEC or several individual FEC units of smaller symbol width (6-12 bits). This also leads to an overall overhead of 2t.
   The use of several FEC sub-codings is expressly preferred here, as this has further positive properties (explained below).
2. The respective current FEC output symbol(s) (not to be confused with the entire FEC coding word n) is then coded using block code in such a way that all the desired properties of DC balance, run length, frequency spectrum etc. are maintained.
   In the case of multiple FEC coding in step 1.), exactly the same number of block coders is used here. On the receive side, this means that a bit error on the link that destroys a complete data symbol of the serial code results in only a single FEC symbol error.

FIG. 3 shows a prior art flowchart where the input data is line coded and then a forward error correction is generated. This forward error correction is appended to the present right-hand side, as shown at the bottom. This means that the data word is first line-encoded at the top and then a non-line-encoded forward error correction is appended. This now presents a problem, as the forward error correction does not have the desired properties that are necessary for robust data transmission. This results in disadvantages because the data is not DC (digital current) balanced, i.e. an advantageous parity is not set. In addition, errors can occur during clock recovery with non-line-coded transmission. In general, line coding is advantageous in that an average value of the analog signals can be measured and then it can be checked which actual signals are above this average value and which are below it. Here it is desirable that the number of analog signals above the mean value, i.e. digital “1”, is equal to the number of analog signals below the mean value, i.e. digital “0”. This means that optimized signal modelling can be carried out. This is not possible in the present FIG. 3, as the forward error correction code is not line coded.

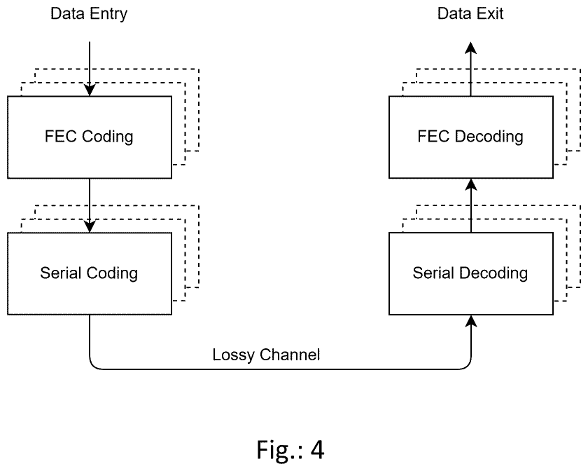

FIG. 4 shows the procedure according to embodiments of the invention and the transmission via a lossy channel. Here, each channel is potentially subject to loss and it is particularly advantageous that the forward error coding takes place first at the data input and then the entire serial coding takes place. On the receiver side, the procedure is carried out in reverse and serial decoding is carried out first, whereby the forward error correction is restored in addition to the user data.

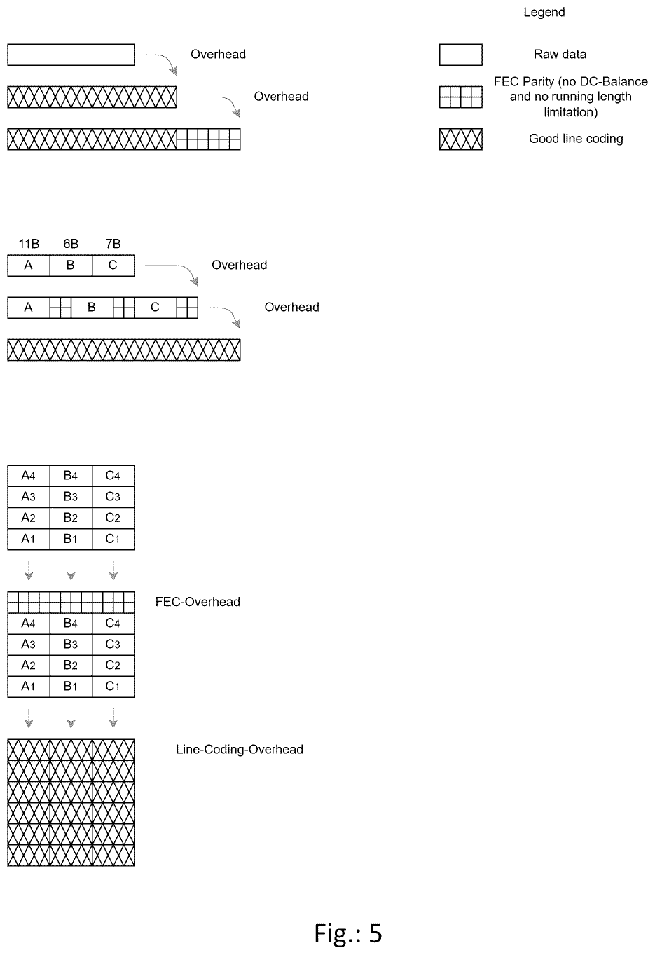

FIG. 5 shows an upper example of a prior art method in which an output data word or a bit sequence is line coded from the first to the second line in a first method step. This results in a code that is longer than the output bit sequence, which is also referred to here as overhead. In a subsequent process step, a forward error correction code is generated from the second line to the third line, which is added to the line coding. As can now be seen, the first part on the left of the data to be transmitted is line coded and the second part, namely the forward error correction, is not line coded. This causes problems, as the advantages of line coding have to be dispensed with in the appendix on the right-hand side. This is disadvantageous.

In the embodiment example in the middle of this figure, the source word ABC is again shown at the top. The bit sequence therefore consists of the segments A, B and C. These are 11 bits, 6 bits and 7 bits long in the present case. In accordance with embodiments of the invention, it is not the entire data word, i.e. the entire bit sequence, that is protected in its entirety, i.e. provided with a forward error correction code, but rather the individual segments are protected. This is shown in the second line by the fact that the corresponding forward error correction code is shown after each segment A, B and C. In a subsequent process step, line coding is applied in the third line or the data from the second line is completely line coded, resulting in a line code in the third line. This can now be transmitted and it can be seen that the entire data is line coded and that the forward error correction code is also line coded. The advantages of line coding therefore apply to all data to be transmitted.

In the embodiment example at the bottom of FIG. 5, the method steps according to embodiments of the invention are shown, whereby further sub-steps are possible. The different bit sequences are shown, whereby the user data has now been divided into bit sequences of the same length. Thus, the entirety of the user data is divided into four bit sequences, which are all of the same length. These four bit sequences are again subdivided into segments of the same length. Figuratively speaking, individual bit sequences are arranged horizontally and these bit sequences are arranged one below the other, so that each line reflects a bit sequence. As can also be seen, the bit sequences are each divided into three segments of equal length. This gives a matrix-like arrangement of the user data in bit sequences per row and segments per column.

Now a line coding is not carried out, as provided for in the prior art, but a partial forward error correction is calculated for each column, i.e. for all segments at the same bit position, in accordance with the subdivision rule as specified in the upper process step. As can be seen in the first line of the second rectangle, a partial forward error correction is shown above, which is referred to in its entirety as FEC overhead in this figure. The segmented bit sequences are now available in accordance with the subdivision rule and the partial forward error corrections are available for all segments of the same bit position across all bit sequences.

A segment encoder is now applied to all segments of the same bit position to generate segment line codes for all segments per bit position and per bit sequence. In a further or in the same process step, the segment encoder that was also used for the segments is applied to the respective partial forward error correction, resulting in a single line code comprising the segment line codes and the partial forward error correction line codes. As can now be seen below in the present FIG. 5, all data has therefore been line coded and, in particular, the forward error correction FEC has also been line coded. This means that this data can now be transmitted advantageously.

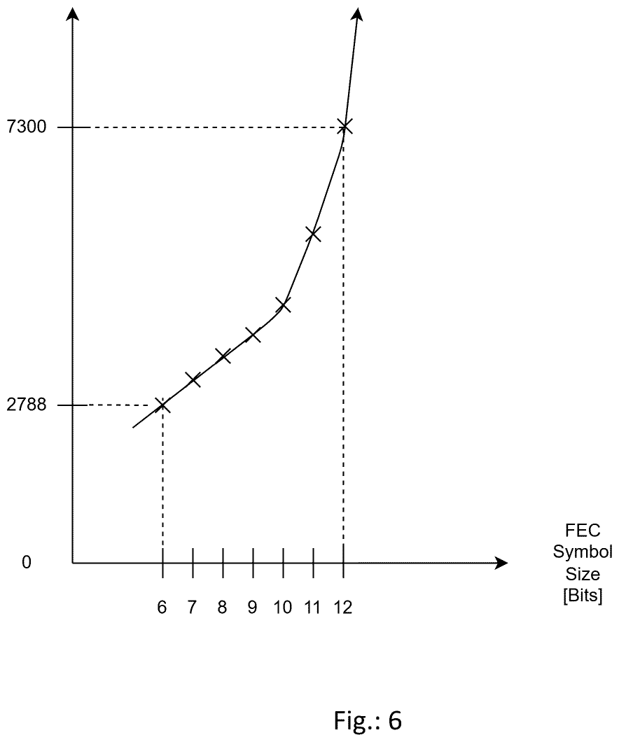

FIG. 6 shows in a diagram on the y-axis the number of gates required when creating a forward error correction code as a function of the bit length to be encoded on the x-axis. As can be seen here, this is an exponential growth and from a bit length of 10-12 bits, the growth of the gates, i.e. the number of gates required for the forward error corrections, increases at an above-average rate. According to embodiments of the invention, it is therefore particularly advantageous to carry out the forward error correction for each segment, as this avoids having to take into account the entire data word, i.e. the entire bit length. If the entire bit length had to be taken into account for the forward error correction, the bit length would typically be beyond the critical 12 bits. The gates required in the forward error correction encoder would increase in an unfavorable manner. This therefore illustrates the advantageous technical effect of embodiments of the present invention, which first form segments via the bit sequence and then calculates the forward error correction on the segments.

At this point, reference is again made to the subdivision rule according to FIG. 5, which provides that a segment can have 11 bits, 6 bits or 7 bits.

By using several FEC encoders/decoders with a smaller FEC symbol size, both the number of required gates is reduced and the maximum operating frequency for a given process node Fmaxis increased (shorter carry chains, more parallelism).

FIG. 6 shows the relationship between the FEC symbol size in bits and the required implementation. This refers to a hardware implementation of a Reed Solomon FEC. The number of gates is normalized (to 12 bit symbol size) and can therefore be compared directly. The exponentially pronounced relationship between symbol size in bits and the implementation in gates can be seen in the graph.

The same symbol widths do not always have to be used for the respective small FEC sub-encoders. Large serial encodings can also consist of several different sub-encoders (the simplest example is 8b10b which can be constructed from 3b4b and 5b6b), as proposed for use with FEC. In the case of embodiments of the present invention or ADXpress (registered trademark), this is achieved by a total of 11 encoders with four basic types: 6b8b, 7b8b, 11b12b and 11b13b. The FEC symbol width used for the respective sub-coding is determined by the data word width of the respective serial encoder. For example, an FEC with a symbol width of 6 bits is used for 6b8b.

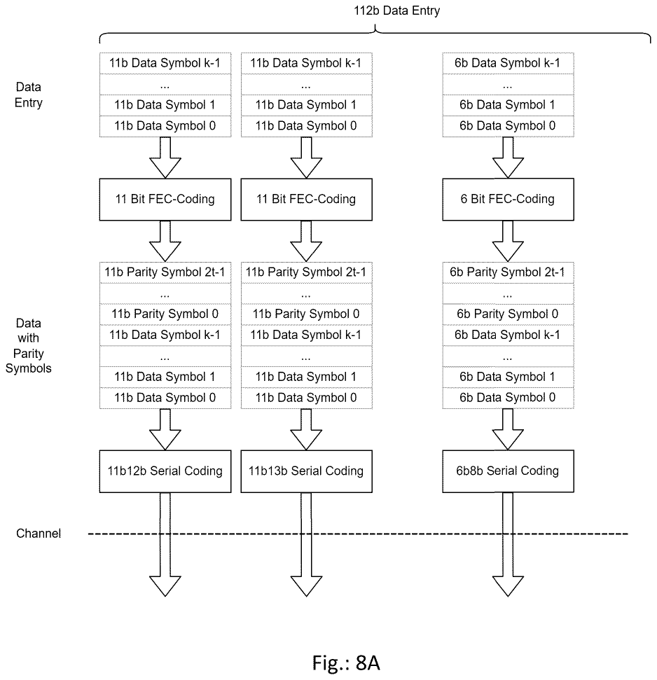

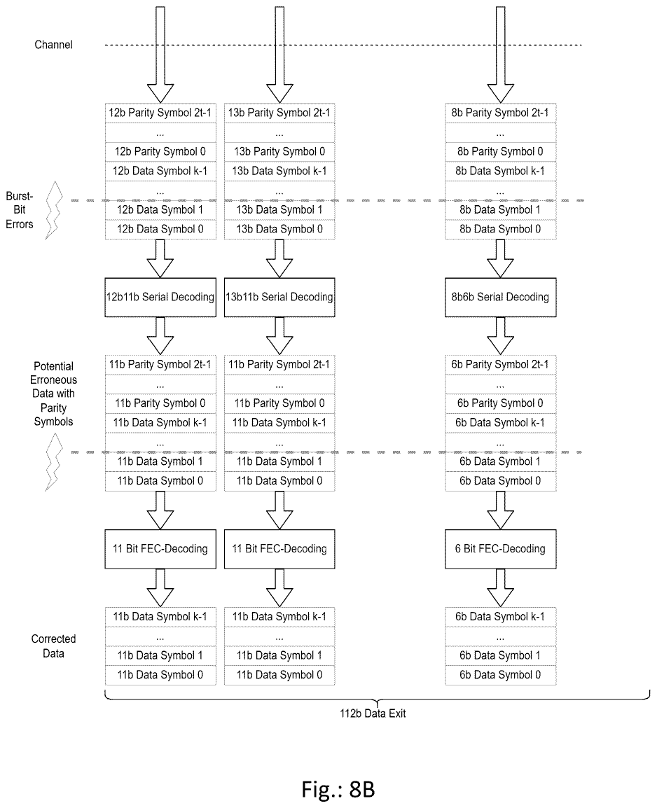

The complete structure for the transmitter data path of embodiments of the present invention or ADXpress (registered trademark) is shown according to one aspect in FIG. 8A. The data path in the receiver has a corresponding inverse structure (see also FIG. 8B).

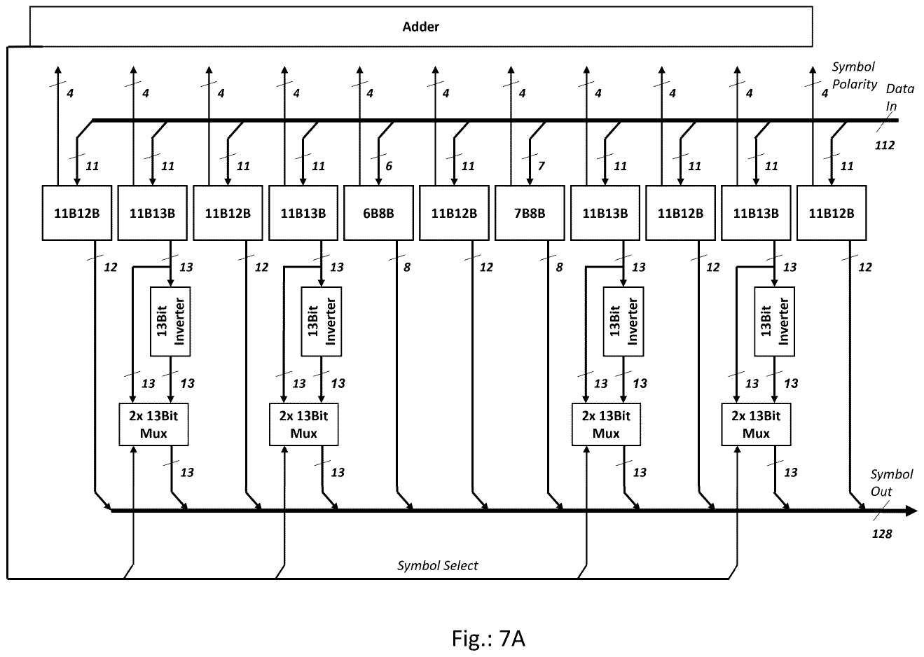

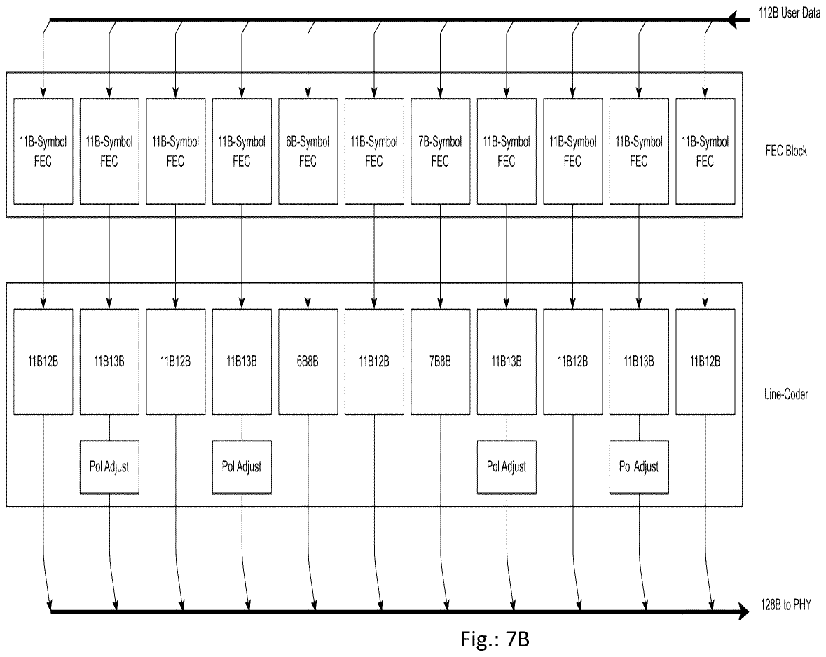

FIG. 7A shows a line coding or a line coding device with several line coding units which, for example, map 11 bits to 12 bits, map 11 bits to 13 bits, or map 11 bits to 12 bits. This corresponds to the right-to-left sequence in FIG. 7 at and illustrates that the input data word, i.e. the bit sequence above, is divided into individual segments and then the individual segments are line coded. The calculation of the forward error correction is not yet taken into account in the present FIG. 7A, so that the system arrangement according to FIG. 7A can serve as the output system arrangement for the present invention.

FIG. 7A shows above the arbitrary bit sequence of 112 bits, which is segmented into 11, 6 or 7 bits. The coding units are then addressed in parallel, which convert the bits into sub-symbols in such a way that they are optimized in terms of disparity. For example, 11 bits are coded after 12 bits or 11 bits after 13 bits.

In this FIG. 7A, a coding unit from the second subset is shown on the far left-hand side in the middle, which is labeled 11B12B. This provides a partial symbol with any sign, i.e. with any disparity. To compensate for this disparity, the coded unit 11B13B is connected downstream in parallel with respect to the bit sequence. This means that a data stream is formed which converts the most significant bits of twice 11 into two sub-symbols, namely once the 11-bit data segment is formed by 11B12B into a 12-bit sub-symbol with any sign, i.e. disparity, and once the data segment is encoded from 11 bits into 13 bits by means of the encoding unit 11B13B. In the figure below the coding units, the second coding unit from the left 11B13B is a coding unit of the first subset. This has an inverter and a multiplexer. The first 13 bits are therefore available as a data stream, which is divided in such a way that it is inverted once with regard to the sign, i.e. the disparity, and once remains unchanged. It is shown below that the positive or negative, i.e. the original or inverted data stream that compensates for the sign from the leftmost coding unit is used under disparity feedback. There are therefore two data streams at the first multiplexer on the left, each of which represents the partial symbol, one with a conventional sign, i.e. as output from the 11-bit 13-bit coding unit, and one with an inverted sign or inverted disparity.

Based on the feedback from the unit at the top, it is therefore determined which disparity results from the leftmost encoder 11B12B and thus the multiplexer, at the bottom left, compensates or minimizes the disparity of the partial symbol of the leftmost encoder 11B12B. This is carried out in parallel in such a way that the coding units from the second subset are followed by coding units from the first subset, which minimize or eliminate the disparity. Finally, the total symbol is output at the bottom right. This total symbol has 128 bits and is made up of the sub-symbols as they are inserted into the bold line below using the slanted arrows. Thus, the sub-symbols which are optimized or minimized with regard to disparity are present on this output line and these sub-symbols form the entire symbol which can then be output and transmitted.

According to one aspect of the present invention, the invention encodes a 112-bit wide data word, with any disparity (disparity max: 112) and any run length (run length max: 112), onto a 128-bit wide symbol. Thus, the overhead resulting from the encoding is 14.2%.

The maximum run length occurring in the symbol, as well as in any sequencing of any symbols, is 8 equal bits.

The maximum disparity in the long average is 0. The disparity in a symbol is less than 9.

The complexity of the logic is minimal, comparable with 10 8B/10B encoders (with the known disadvantage of the large overhead).

This is achieved by the use, or parallel use, of several “small” encoders that are optimally matched to each other in terms of their disparity and run length characteristics.

The 11B12B, 7B8B and 6B8B encoders generate all symbols with a guaranteed maximum run length of 6, even if the (partial) symbols are sequenced in any order.

According to one aspect of the present invention, the encoder (11B13B) generates symbols with a guaranteed maximum run length of 7 or at the beginning or end of the symbol of 5. Due to the sequencing (FIG. 2) of (11B13B) with the other encoders, a maximum run length of 8 can thus be generated in the symbol.

See properties of the encoder as follows:
118138: 11 bit data is mapped to 2048 symbols with 13 bits. The symbols can be transmitted in inverted or non-inverted form.
   Disparity:
   +3 . . . +9 or controllable −3 . . . −9
   Run length in the word: 7
   Run length at the edge: 5.
11B13B: 11-bit data is mapped to 2048 symbols with 13 bits. The symbols can be transmitted in inverted or non-inverted form.
   Disparity: +3 . . . +9 or controllable −3 . . . 9
   Run length in the word: 7
   Run length at the edge: 5
11B12B: 11-bit data is mapped to 2048 symbols with 12 bits. The symbols are only transmitted non-inverted.
   Disparity: −2, −1, 0, 1, 2
   Run length in the word: 6
   Run length at the edge: 3
7B8B: 7-bit data is mapped to 128 symbols with 8 bits. The only transmitted non-inverted.
   Disparity: −2, −1, 0, 1, 2
   Run length in the word: 6
   Run length at the edge: 3 symbols are
6B8B: 6-bit data is mapped to 64 symbols with 8 bits. The symbols are only transmitted non-inverted.
   Disparity: 0
   Run length in the word: 6
   Run length at the edge: 3

With the four 11B13B encoders, a disparity of at least +−12 can be controllably generated in order to compensate for the uncontrollable disparity of a maximum of +−12 (6 x+−2) of the 11B12B and 7B8B encoders, so that a balanced disparity can be reliably achieved irrespective of the data to be transmitted.

In order to further reduce the complexity of the hardware, four small encoders (11B13B) are used according to one aspect of the present invention, the disparity of which can be controlled with regard to sign (+−).

According to one aspect of the present invention, the symbol disparity is controlled in such a way that each encoder calculates the parity of “its” sub-symbol. This is done with little effort, since the subsymbol has only a few bits.

With four of the eleven encoders, the sign of the disparity of the subsymbol can be actively controlled by inverting the generated subsymbol. For this purpose, the encoders (11B13B) have the special feature that their symbols generate a symbol with positive disparity (+3 . . . +9) for all input data. By inverting the partial symbol, a symbol with negative disparity (−3 . . . −9) is obtained.

In this way, the disparity (−2,−1,0,1,2) of the partial symbols of the other encoders (11B12B and 7B8B) can be compensated. The encoder 6B8B generates symbols whose disparity is always 0. Then all (partial) parities of the encoders (11B12B and 7B8B) are added together and the result controls the decision as to how many inverted and non-inverted symbols of the encoder (11B13B) are used.

The minimum (smallest) disparity of the encoder 11B13B is +−3. So in total, a disparity of +−12 (4*+−3) per symbol can be safely compensated with these four encoders.

Furthermore, five (11B12B) encoders and one (7B8B) encoder are used whose maximum disparity is +−2. So in the extreme case, these six encoders generate a disparity of exactly +−12 (2*+−6). This can be safely compensated by the 11B13B encoders.

According to one aspect of the present invention, the method achieves the same quality as an 8B10B code but with half the overhead (loss due to encoding).

The implementation of the encoding and decoding hardware requires minimal resources (logic) due to the use of multiple small encoders instead of one large one.

Encoding can typically be done completely in one cycle of the parallel data path (no pipelining necessary).

The control of the disparity of the 128 bit symbol can be realized with (very) little logic, and can be realized completely within one clock cycle of the data path (slow), instead of calculating the disparity by counting the one and zero bits in the serial data stream with the very fast serial clock.

Due to the deterministic disparity and run length, further scrambling is not necessary and therefore fast synchronization to the data stream on the receiver side is possible (no scrambler synchronization required).

Among other things, this is very useful for power save modes in which the link can be switched off to save energy and switched on again when required. For this, fast synchronization between transmitter and receiver is a must.

According to one aspect of the present invention, the invention encodes a 112-bit wide data word, with any disparity (disparity max: 112) and any run length (run length max: 112), onto a 128-bit wide symbol. The overhead resulting from the coding is therefore 14.2%.

The maximum run length occurring in the symbol, as well as with any sequencing of any symbols, is 8 equal bits.

The maximum disparity in the long mean is 0. The disparity in a symbol is less than 9.

The complexity of the logic is minimal, comparable with 10 8B/10B encoders (with the known disadvantage of the large overhead).

This is achieved by the use, or parallel use, of several “small” encoders that are optimally matched to each other in terms of their disparity and run length characteristics.

The 11B12B, 7B8B and 6B8B encoders generate all symbols with a guaranteed maximum run length of 6, even if the (partial) symbols are sequenced in any order.

According to one aspect of the present invention, the encoder (11B13B) generates symbols with a guaranteed maximum run length of 7 or at the beginning or end of the symbol of 5. Due to the sequencing (FIG. 2) of (11B13B) with the other encoders, a maximum run length of 8 can thus be generated in the symbol.

See properties of the encoder as follows:

To further reduce the complexity of the hardware, four small encoders (11B13B) are used whose disparity can be controlled in terms of sign (+−).

According to one aspect of the present invention, the symbol disparity is controlled in such a way that each encoder calculates the parity of “its” sub-symbol. This is done with little effort, since the subsymbol has only a few bits.

With four of the eleven encoders, the sign of the disparity of the subsymbol can be actively controlled by inverting the generated subsymbol. For this purpose, the encoders (11B13B) have the special feature that their symbols generate a symbol with positive disparity (+3 . . . +9) for all input data. By inverting the partial symbol, a symbol with negative disparity (−3 . . . −9) is obtained.

In this way, the disparity (−2,−1,0,1,2) of the partial symbols of the other encoders (11B12B and 7B8B) can be compensated. The encoder 6B8B generates symbols whose disparity is always 0. Then all (partial) parities of the encoders (11B12B and 7B8B) are added together and the result controls the decision as to how many inverted and non-inverted symbols of the encoder (11B13B) are used.

The minimum (smallest) disparity of the encoder 11B13B is +−3. So in total, a disparity of +−12 (4*+−3) per symbol can be safely compensated with these four encoders.

Furthermore, five (11B12B) encoders and one (7B8B) encoder are used whose maximum disparity is +−2. So in the extreme case, these six encoders generate exactly a disparity of +−12 (2*+−6). This can be safely compensated by the 11B13B encoders.

The method achieves the same quality as an 8B10B code but with half the overhead (loss due to coding).

The implementation of the encoding and decoding hardware requires only minimal resources (logic) due to the use of several small encoders instead of one large one.

Encoding can typically be done completely in one cycle of the parallel data path (no pipelining necessary).

The control of the disparity of the 128 bit symbol can be realized with (very) little logic, and can be realized completely within one clock cycle of the data path (slow), instead of calculating the disparity by counting the one and zero bits in the serial data stream with the very fast serial clock.

Due to the deterministic disparity and run length, further scrambling is not necessary and therefore fast synchronization to the data stream is possible on the receiver side (no scrambler synchronization required).

Among other things, this is very useful for power save modes in which the link can be switched off to save energy and switched on again when required. For this, fast synchronization between transmitter and receiver is a must.

FIG. 7B now shows the adapted system arrangement from FIG. 7A, with the corresponding partial forward error correction encoders now drawn in. These are referred to here as FEC blocks. This figure therefore shows that segments are first formed from the bit sequences, which corresponds to the upper arrows pointing downwards from the user data. This is where the partial forward error corrections are generated and then fed into the coding units, as already shown in FIG. 7A. The line coding units are referred to here as line coders and encode both the segments of the bit sequences and the partial forward error corrections. The parity can also be adjusted in optional process steps. The line-encoded data is then output at the bottom and transmitted to the right via a potentially error-prone communication channel to a receiver, not shown here.

FIG. 8A shows the method according to embodiments of the invention for improving forward error correction and shows in particular the process steps that are carried out on the transmitter side. The arrows at the bottom of this FIG. 8A correspond to the arrow at the top of the following FIG. 8B. The data is therefore entered as shown in FIG. 8A and then the partial forward error correction is calculated. As can be seen above, all segments are of the same bit length. This means that the first column comprises 11 bits, the second column comprises 11 bits and the last column comprises 6 bits.

A partial forward error correction is now generated for all segments of the same bit sequence, which has the same bit length as the corresponding segments. This results in the data with a parity symbol. In a final process step, serial line coding takes place, which maps 11 bits to 12 bits or 11 bits to 13 bits or 6 bits to 8 bits, for example. This data can now be transmitted via the potentially interference-prone channel. This results in a transmission as shown in FIG. 8A below or in FIG. 8B above.

FIG. 8B shows the procedure on the receiver side and corresponds inversely to the procedure in FIG. 8A. As is also shown in the present FIG. 8B, it is recognized that bit errors may be present, but that these can be handled particularly advantageously at segment level. The bit errors therefore do not occur in the entire bit sequence, but only on individual segments and can therefore be treated advantageously. This leads to the corrected data as shown in FIG. 8B below and the 112 bits are thus recovered, as they served as the output in FIG. 8A.

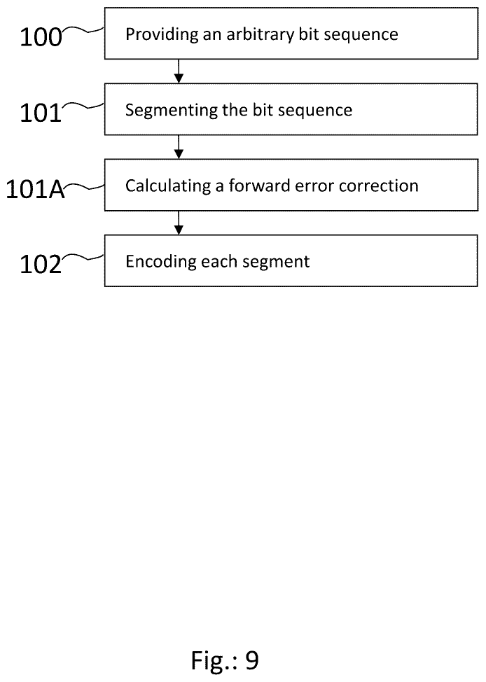

FIG. 9 shows in a flowchart a method in an automobile for generating an efficiently transmittable bit sequence with a restricted disparity, a restricted run length and a line-coded forward error correction, comprising providing 100 any bit sequence; segmenting 101 the provided bit sequence into a predefined sequence of segments according to a respective predefined bit length; calculating 101A a forward error correction for each of the segments or a plurality of segments of the same bit length; encoding 102 each segment or a plurality of segments of the same bit position together with its forward error correction into one or more sub-symbols, respectively, using the same encoding unit for the segments of the same bit position and the associated forward error correction from a plurality of encoding units, respectively, wherein a first subset of coding units actively controls a sign of the disparity of the subsymbol by inverting the disparity of the generated subsymbol to compensate for a disparity of a second subset of coding units, wherein a juxtaposition of the subsymbols results in the efficiently transferable bit sequence together with the calculated forward error corrections.

All segment line codes and all partial forward error correction line codes are also transferred: In this last step, all generated segment guidance codes and partial forward error correction guidance codes are transmitted. These transmitted codes contain the error detection and correction information for the corresponding segments and partial forward error corrections. The method described enables improved forward error correction during serial coding and data transmission in the vehicle. By dividing the user data into segments and applying specific coding procedures to these segments, effective error detection and correction is achieved at segment level.

By iteratively creating a partial forward error correction for all segments of the same bit position and applying a segment encoder to each segment, targeted error correction for the transmitted data is made possible. The partial forward error correction line codes contain the necessary information to detect and correct errors, while the segment line codes represent the structure and content of the segments and also contribute to error detection and correction.

By transmitting all the generated segment line codes and partial forward error correction line codes, the receiver can analyze the received data accordingly and detect and correct errors to ensure reliable and accurate transmission of the user data in the vehicle.

The method described thus provides improved forward error correction, which is particularly important in challenging environments such as vehicles where interference and signal loss can occur. It helps to ensure reliable and high-quality data transmission, which is of great importance for various applications in the vehicle sector, such as autonomous driving, vehicle safety systems and infotainment applications.

The invention makes it possible to maintain all the desired properties and requirements of the serial coding at all times while operating an FEC efficiently. By deliberately positioning the serial encoder after the FEC units, the physical behavior on the link is always deterministically controllable (not the case with scrambler as serial encoding).

In addition, the selection of the FEC symbol size based on the data word size of the respective serial sub-encoder always ensures that bit errors always propagate to a minimum (a defective line code symbol then only generates a defective FEC symbol).

Furthermore, the use of several FEC sub-encoders creates a very efficient type of so-called interleaving. This is possible without time-consuming manual interleaving of the symbols, which would always require data to be held (more latency and buffer). This also makes it possible to correct burst errors, e.g. 112/128 bit errors at once.

It can only be seen from the schematic structure in FIGS. 7A, 7B and 8A, 8B that this is the case: in this case, 128 bit errors lead to only one symbol error of the respective FEC sub-encoder. With classic single FEC coding, a burst error of the same length (128 erroneous bits in succession) would generate several symbol errors in succession. Depending on the encoding selected, this can lead to the FEC word (all symbols of an FEC cycle) no longer being able to be decoded (this also makes correction impossible). This is normally achieved by interleaving the symbols of an FEC cycle with those of one or more other FEC cycles. However, this is only possible by using buffers on the transmitter and receiver side in order to be able to interleave the data in the case of the transmitter and to bring this back into the original continuous FEC symbol data stream of the individual FEC cycles in the receiver by means of the inverse operation. By using several small FEC encoders, interleaving and thus also the provision of the buffers required for interleaving becomes superfluous (but only to a certain extent, a burst error of more than the 128 bits in a row mentioned in the example leads to more than one symbol being damaged per individual FEC).

How many symbols a respective FEC sub-encoder can repair (t) depends on the overhead 2t see FIG. 2. This must be selected accordingly for the desired application. The case shown in FIG. 8A with one symbol error per FEC sub-encoder is already reached at t=1 (i.e. two parity symbols overhead). It should also be noted that the burst error may/can also occur without any restrictions in the area of the parity symbols.

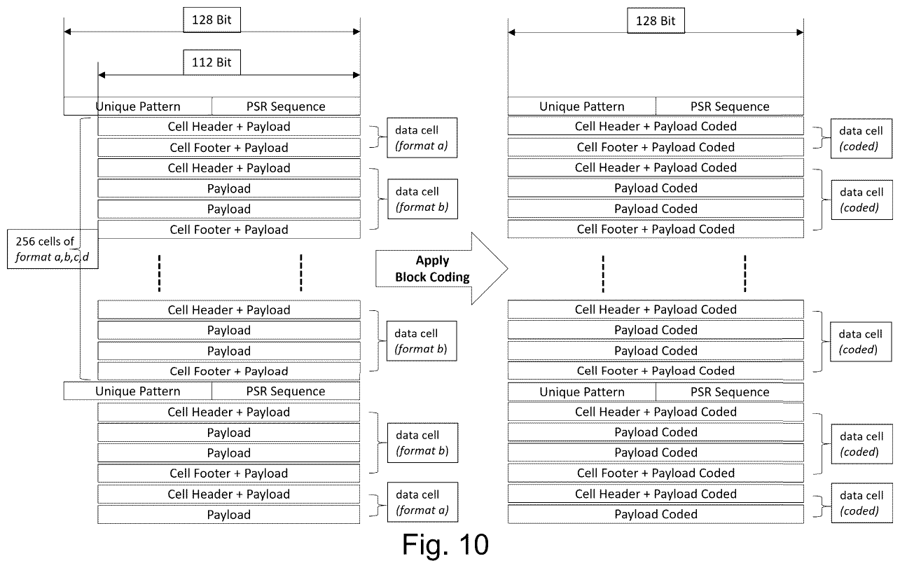

FIG. 10 shows a data format that displays an arbitrary bit sequence on the left-hand side and partial symbols on the right-hand side. The data to be encoded has 112 bits and the sub-symbols have 128 bits. In this way, an arbitrary bit sequence of 112 bits is encoded to a total symbol of 128 bits. The coded 128 bits are optimized in terms of disparity. The arrow in the center indicates that the coding units translate the data segments on the left side into sub-symbols on the right side. The figure also shows that the method can be used multiple times, so that any number of bit sequences can be translated into any number of total symbols. In addition, the data can be divided into different data cells or data frames.

Even if the data on the left-hand side has the same semantic content as the data on the right-hand side, the data on the right-hand side is encoded in such a way that its disparity is optimized. In general, the present method can be applied to any data, hence the arbitrary bit sequence, and both user data and header data can be transferred.

The data fields shown are merely examples and form an application example of the present invention.

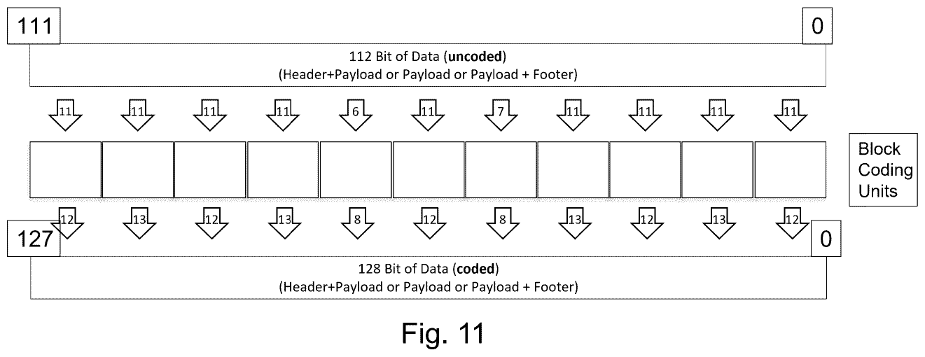

FIG. 11 shows the encoding units in the center together with the inputs and outputs. The output data consists of 112 bits, which have the index 0-111. These are broken down into segments which have 11, 6, 7 or other bit length assignments. In this example, these segments are translated into sub-symbols of 12, 13, 8 or other data lengths. The proposed example is particularly advantageous because it encodes 112 bits into 128 bits, thereby achieving a particularly high degree of efficiency. The 128 bits have the same content as the bit sequence to be encoded and are only 16 bits longer.

The figure on the left shows that the arbitrary bit sequence of 112 bits is segmented into data segments of 11 bits and then encoded into 12 bits using the encoding unit 11B12B.

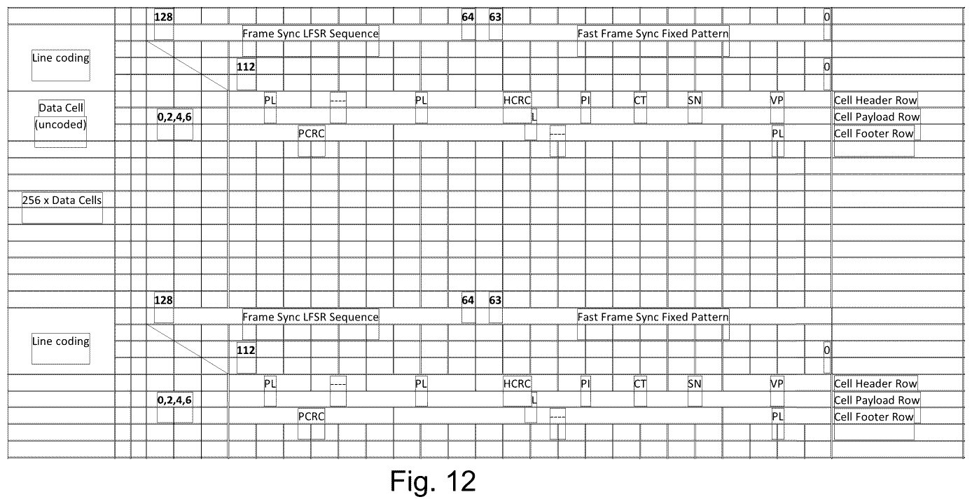

FIG. 12 shows a data format that can be used, for example, in FIG. 10 or 11. Again, the 128-bit total symbol and the arbitrary data sequence of 112 bits are shown. Overall, the arbitrary bit sequence and the total symbol can have different header data or frame data.

In the following, some concrete possibilities are created as to how segments of the arbitrary bit sequence can be translated into sub-symbols so that the disparity is minimized or eliminated. A first table shows a translation from 6 bits to 8 bits, a second table shows a translation from 7 bits to 8 bits, a third table shows a translation from 11 bits to 12 bits and a fourth table shows a translation from 11 bits to 13 bits. Segments of 6, 7 or 11 bits are thus converted into sub-symbols of 8, 12 or 13 bits. The encodings shown are exemplary and illustrate the technical effect that is achieved in the present case. Embodiments of the present invention has been empirically evaluated and, based on the proposed encoding, achieves that 112 bits can be optimized with respect to their disparity in such a way that only 128 bits are required. This corresponds to a so-called overhead of only 14%.

In the present case, cells are used as a synonym for frames. These can also be packets.

### Cell Format/Frame Format

According to one aspect of the present invention, the cell comprises a header with a fixed bit length, a payload area with 4 selectable bit lengths and a footer, again with a fixed bit length.

The cell structure is a sequence of bits as follows:
A 7-bit virtual path identifier (VP), which is a unique address of the virtual path.
A 3-bit sequence number (SN), which numbers the cells consecutively in sequence.
A 2-bit wide Cell Type (CT) identifier that specifies the length of the user data.
A 3-bit wide Payload Information (PI), which contains additional information about the payload. This can also be used to synchronize payload data and frame data or control data.
A 10-bit wide CRC polynomial (HCRC) for error protection of the header information. The polynomial has a Hamming distance of 5 up to a bit sequence of 21 bits (P=0x2B9).
The payload (PL) range has a length of: 187, 411, 635 or 859 bits, depending on the CT value. The shortest payload is selected so that it is still larger than the largest supported (video) streaming bus width. (Should simplify the mapping of streaming data to the cell payload).
Finally, a 12-bit wide CRC polynomial (PCRC) for error protection of the user data. The polynomial has a Hamming distance of 4 up to a bit sequence of 2035 bits (P=0x8F3).

### Format of the Transmission Frame

According to an aspect of the present invention, the transmission frame comprises a sequence of M-bit wide words. The frame starts with an M-bit wide “comma” word from a defined sequence of comma words for the frame alignment. This is followed by K cells. The cells consist of 2, 4, 6 or 8 N-bit wide words that carry the header, payload and footer. These N-bit wide words are encoded into M-bit wide symbols (line encoding).

This format is chosen to enable the processing of cell data at appropriate time frequencies, provided that the serializer/deserializer always processes a block of M bits.

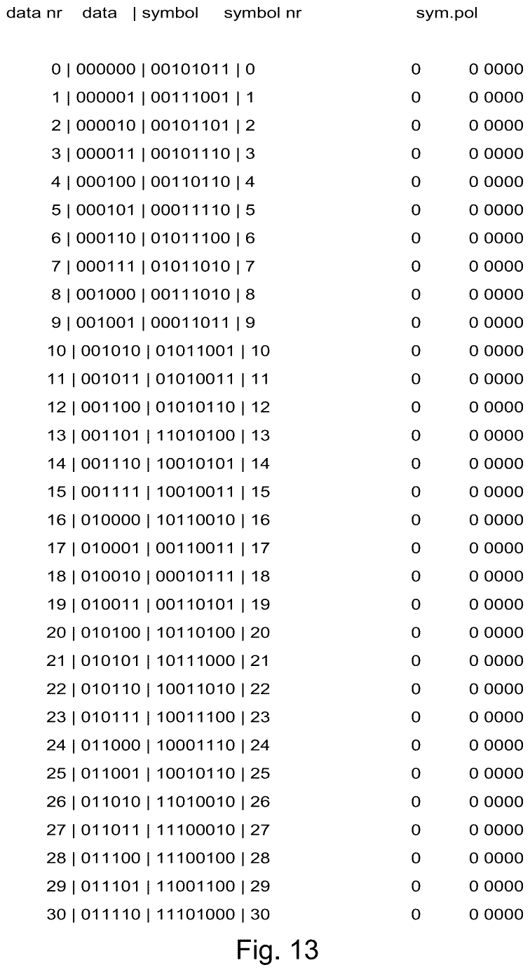

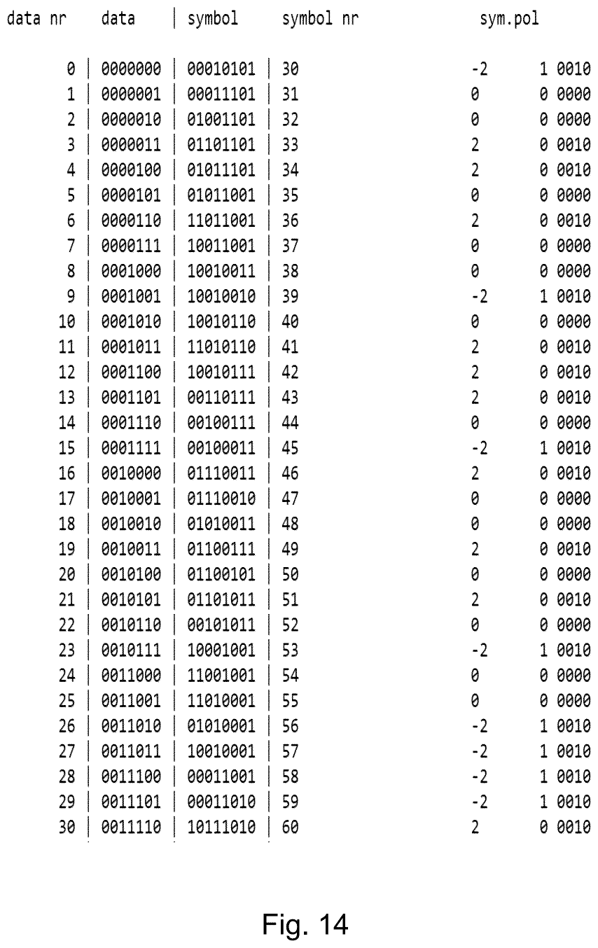

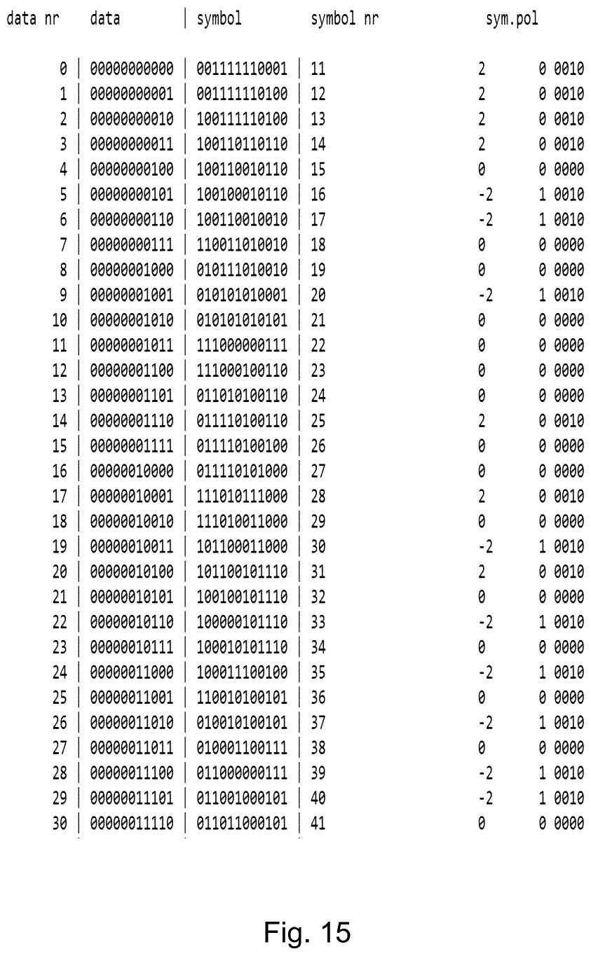

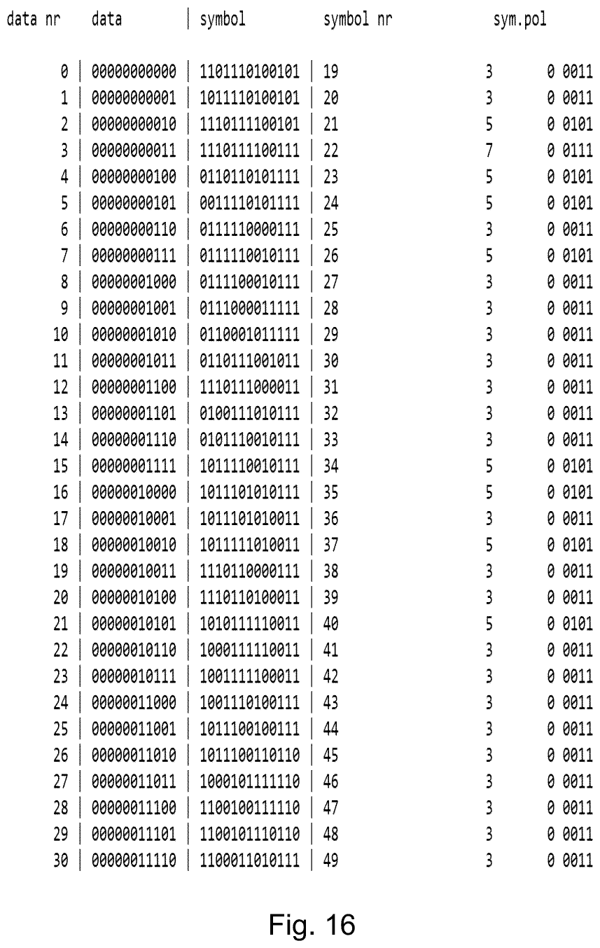

FIG. 13 shows a portion of an exemplary encoding of data segments to symbols, wherein 6 bits are encoded to 8 bits such that the disparity is optimized according to an aspect of the present invention. For example, a segment 000000 is encoded to a partial symbol 00101011, i.e. a 6B8B encoder. Furthermore, FIG. 14 shows a 7B8B encoder, FIG. 15 shows an 11B12B encoder and FIG. 16 shows an 11B13B encoder.

What is claimed is:

1. A method for use in an automobile for generating an efficiently transmittable bit sequence as a total symbol sequence with a restricted disparity, a restricted run length and a line coded forward error correction, comprising:
providing (100) user data and subdivisions of user data in a bit sequence of the same length;
segmenting (101) the provided bit sequence into a predefined sequence of segments according to a respective predefined bit length at a predetermined bit position in accordance with a read-out subdivision rule;
calculating (101A) a forward error correction for each of the segments or a plurality of segments of the same bit length; wherein the forward error correction is calculated (101A) for each of the segments in such a way that segments at the same bit position are grouped together and the forward error correction is formed on this basis;
line coding (102) each segment of the same bit position together with its forward error correction into one or more sub-symbols, using the same encoding unit for the segments of the same bit position and the associated forward error correction from a plurality of encoding units, whereby the respective encoding unit used takes into account the predefined bit length, wherein a first subset of coding units actively controls a sign of the disparity of the partial symbol by inverting the disparity of the generated partial symbol to compensate a disparity of a second subset of coding units, wherein a juxtaposition of the partial symbols results, which, according to the order of the segmented (101) predefined sequence, in the efficiently transmittable bit sequence together with the calculated forward error corrections wherein the active control of the sign is performed by dividing the generated partial symbol into two data streams and conditionally inverting the partial symbol in each case, wherein a multiplexer selects, when a data stream that is positive with respect to the disparity and a data stream that is negative are present, the data stream that contributes to minimising the total disparity of the overall symbol.

2. The method of claim 1, wherein the disparity of the second subset of coding units is not controllable.

3. The method of claim 1, wherein a totality of the partial forward error corrections describes the provided bit sequence in a correctable manner.

4. The method of claim 1, wherein the coding units have a minimum number of gates with respect to the predefined bit lengths.

5. The method of claim 1, wherein a calculation unit for calculating the forward error correction is connected upstream of each coding unit.

6. The method of claim 1, wherein coding units of the first subset code segments of 11 bits to subsymbols of 13 bits.

7. The method of claim 1, wherein coding units of the first subset have a disparity between +3 and +9, which are specifically inverted to −3 to −9 by bitwise inversion of the partial symbol.

8. The method of claim 1, wherein the run length in partial symbols is at most 7.

9. The method of claim 1, wherein the run length of the partial symbol in coding units of the first subset is at most 5, starting from the most significant and/or the least significant bit.

10. The method of claim 1, wherein, in the case of coding units of the second subset, 11-bit segments are coded to 12-bit subsymbols or 7-bit segments are coded to 8-bit subsymbols or 6-bit segments are coded to 8-bit subsymbols.

11. A system arrangement for use in an automobile for generating an efficiently transferable bit sequence as a total symbol sequence with a restricted disparity and a restricted run length, comprising
an interface unit arranged to provide (100) user data and subdivisions of user data in a bit sequence of the same length;
a segmentation unit adapted to segment (101) the provided bit sequences into a predefined sequences of segments according to a respective predefined bit length at a predetermined bit position in accordance with a read-out subdivision rule;
a calculation unit arranged to calculate (101A) a forward error correction for each of the segments, wherein the forward error correction is calculated (101A) for each of the segments in such a way that segments at the same bit position are grouped together and the forward error correction is formed on this basis;
an encoding arrangement arranged for line coding (102) each segment of the same bit position together with its/their forward error correction into one or more partial symbols in each case, using in each case the same encoding unit for the segments of the same bit position and the associated forward error correction from a plurality of encoding units, whereby the respective encoding unit used takes into account the predefined bit length, wherein a first subset of encoding units actively controls a sign of the disparity of the subsymbol by inverting the disparity of the generated subsymbol to compensate a disparity of a second subset of encoding units, wherein a concatenation of the subsymbols according to the order of the segmented (101) predefined sequence results in the efficiently transferable bit sequence together with the calculated forward error corrections, wherein the active control of the sign is performed by dividing the generated partial symbol into two data streams and conditionally inverting the partial symbol in each case, wherein a multiplexer selects, when a data stream that is positive with respect to the disparity and a data stream that is negative are present, the data stream that contributes to minimising the total disparity of the overall symbol.

12. A computer program product comprising instructions fixed in a non-transitory medium which, when the program is executed by at least one computer, cause the computer to perform the steps of the method of claim 1.

13. A non-transitory computer readable storage medium comprising instructions which, when executed by at least one computer, cause the computer to perform the steps of the method of claim 1.
